(19) United States
(12) Patent Application Publication
(10) Pub. No.: US 2026/0246027 A1
(43) Pub. Date: Aug. 20, 2026

(54) BATTERY PACK

(71) Applicant: MURATA MANUFACTURING CO., LTD., Kyoto (JP)

(72) Inventor: Yoshiyuki BANNAI, Kyoto (JP)

(21) Appl. No.: 19/661,890

(22) Filed: Apr. 29, 2026

Related U.S. Application Data
(63) Continuation of application No. PCT/JP2024/042500, filed on Dec. 2, 2024.

(30) Foreign Application Priority Data
Mar. 4, 2024 (JP) 2024-032296

(51) Int. Cl. H01M 10/659; H01M 10/42; H01M 10/613; H01M 10/643; H01M 50/213; H01M 50/284; H01M 50/474; H01M 50/503; H01M 50/507; H01M 50/517; H01M 50/519; H01M 50/548

(52) U.S. Cl. CPC H01M 10/659; H01M 10/425; H01M 10/613; H01M 10/643; H01M 50/213; H01M 50/284; H01M 50/474; H01M 50/503; H01M 50/507; H01M 50/517; H01M 50/519; H01M 50/548

(57) ABSTRACT

A battery pack is provided and includes a battery unit. The battery unit includes multiple batteries and one or more heat-absorbing members. For example, the one or more heat-absorbing members each include a heat-absorbing agent and a housing body housing the heat-absorbing agent. The one or more heat-absorbing members each extend in an axial direction of the batteries, and are each disposed to be adjacent to at least two of the batteries. The battery unit further includes a battery holder, a first tab, and a second tab. The battery holder holds the batteries. The first tab is coupled to a terminal on one end side of each of the batteries. The second tab is coupled to a terminal on another end side of each of the batteries. The first tab is provided to cover, when the battery unit is viewed in the axial direction of the batteries, one end of each of the one or more heat-absorbing members. The second tab is provided to cover, when the battery unit is viewed in the axial direction of the batteries, another end of each of the one or more heat-absorbing members.

### CROSS REFERENCE TO RELATED APPLICATIONS

The present application is a continuation of International Application No. PCT/JP2024/042500, filed on Dec. 2, 2024, which claims priority to Japanese patent application no. 2024-032296, filed on Mar. 4, 2024, the entire contents of which is incorporated herein by reference.

### BACKGROUND

The present technology relates to a battery pack.

Electronic equipment has been widely used. Such widespread use has promoted development of a battery as a power source that is to be applied to the electronic equipment. In this case, in order to handle multiple batteries easily and safely, a battery pack including the multiple batteries has been proposed.

A technique related to a configuration of the battery pack has been considered in various ways. Specifically, a heat-absorbing member is in contact with a side surface of a battery unit, and the heat-absorbing member includes an outer film containing a gel fluid as a heat-absorbing agent inside.

### SUMMARY

The present technology relates to a battery pack.

A heat-absorbing member exhibits high heat absorption performance when an outer package film cleaves and a heat-absorbing agent leaks out. However, when a battery pack has a structure in which the heat-absorbing agent leaked from the heat-absorbing member does not remain in the battery unit but is discharged to an outside, the heat absorption performance with the heat-absorbing agent can be decreased. In the battery pack, a structure exhibiting high heat absorption performance with the heat-absorbing agent is desired. It is desirable to provide a battery pack having a structure exhibiting high heat absorption performance with a heat-absorbing agent.

A battery pack according to an embodiment of the present technology includes a battery unit. The battery unit includes multiple batteries and one or more heat-absorbing members. The one or more heat-absorbing members each include a heat-absorbing agent and a housing body housing the heat-absorbing agent. The one or more heat-absorbing members each extend in an axial direction of the batteries, and are each disposed to be adjacent to at least two of the batteries. The battery unit further includes a battery holder, a first tab, and a second tab. The battery holder holds the batteries. The first tab is coupled to a terminal on one end side of each of the batteries. The second tab is coupled to a terminal on another end side of each of the batteries. The first tab is provided to cover, when the battery unit is viewed in the axial direction of the batteries, one end of each of the one or more heat-absorbing members. The second tab is provided to cover, when the battery unit is viewed in the axial direction of the batteries, another end of each of the one or more heat-absorbing members.

According to an embodiment of the present technology, the first tab is provided to cover, when the battery unit is viewed in the axial direction of the batteries, the one end of each of the one or more heat-absorbing members, and the second tab is provided to cover, when the battery unit is viewed in the axial direction of the batteries, the other end of each of the one or more heat-absorbing members. Accordingly, when the housing body cleaves and the heat-absorbing agent leaks out, the first tab and the second tab each operate as a wall, which makes it possible to retain the heat-absorbing agent within the battery unit. This makes it possible to suppress a decrease in heat absorption performance with the heat-absorbing agent. It is therefore possible to provide the battery pack having a structure exhibiting high heat absorption performance with the heat-absorbing agent.

### BRIEF DESCRIPTION OF THE FIGURES

FIG. 1 is a diagram illustrating a perspective configuration example of a battery pack according to an embodiment of the present technology.

FIG. 2 is a diagram illustrating a perspective configuration example of components housed in the battery pack.

FIG. 3 is a diagram illustrating an exploded perspective configuration example of the battery pack.

FIG. 4 is a diagram illustrating a sectional configuration example of a battery holder.

FIG. 5 is a diagram illustrating a sectional configuration example of the battery holder.

FIG. 6 is a diagram illustrating an example of an arrangement of multiple batteries in a battery unit.

Part (A) of FIG. 7 is a diagram illustrating a sectional configuration example of a heat-absorbing member, and part (B) of FIG. 7 is a diagram illustrating a sectional configuration example of the heat-absorbing member of part (A) of FIG. 7 taken along line A-A.

FIG. 8 is a diagram illustrating an exploded perspective configuration example of a first tab.

FIG. 9 is a diagram illustrating a planar configuration example of two power extraction tab parts and an intermediate coupling tab part included in the first tab.

FIG. 10 is a diagram illustrating a configuration example in which a planar configuration of the batteries and the heat-absorbing members is superimposed on the planar configuration of FIG. 9.

FIG. 11 is a diagram illustrating a sectional configuration example of FIG. 9 taken along line A-A.

FIG. 12 is a diagram illustrating an exploded perspective configuration example of a second tab.

FIG. 13 is a diagram illustrating a planar configuration example of two intermediate coupling tab parts included in the second tab.

FIG. 14 is a diagram illustrating a configuration example in which a planar configuration of the batteries and the heat-absorbing members is superimposed on the planar configuration of FIG. 13.

FIG. 15 is a diagram illustrating a sectional configuration example of FIG. 13 taken along line A-A.

FIG. 16 is a diagram illustrating a procedure of engaging a hook included in each of the first tab and the second tab with a control board.

FIG. 17 is a diagram illustrating a modification example of the arrangement of the multiple batteries in the battery unit.

FIG. 18 is a diagram illustrating an example of a tab coupled to a terminal on one end side of each of the multiple batteries of FIG. 17.

FIG. 19 is a diagram illustrating a modification example of the planar configuration of FIG. 10.

FIG. 20 is a diagram illustrating a modification example of the planar configuration of FIG. 14.

FIG. 21 is a diagram illustrating amodification example of the planar configuration of FIG. 10.

FIG. 22 is a diagram illustrating a modification example of the planar configuration of FIG. 14.

FIG. 23 is a diagram illustrating a modification example of a perspective configuration of the first tab.

FIG. 24 is a diagram illustrating a sectional configuration example of FIG. 23 taken along line A-A.

FIG. 25 is a diagram illustrating a modification example of a perspective configuration of the second tab.

FIG. 26 is a diagram illustrating a sectional configuration example of FIG. 25 taken along line A-A.

FIG. 27 is a diagram illustrating a perspective configuration example of a battery pack according to an embodiment of the present technology.

FIG. 28 is a diagram illustrating a perspective configuration example of components housed in the battery pack.

FIG. 29 is a diagram illustrating an exploded perspective configuration example of the battery pack.

FIG. 30 is a diagram illustrating an exploded perspective configuration example of a first tab.

Part (A) of FIG. 31 is a diagram illustrating a planar configuration example of two power extraction tab parts included in the first tab, and part (B) of FIG. 31 is a diagram illustrating a configuration example in which a planar configuration of the batteries and a heat-absorbing member is superimposed on the planar configuration of part (A) of FIG. 31.

FIG. 32 is a diagram illustrating a sectional configuration example of part (A) of FIG. 31 taken along line A-A.

FIG. 33 is a diagram illustrating a perspective configuration example of a second tab.

FIG. 34 is a diagram illustrating a modification example of the planar configuration of part (B) of FIG. 31.

FIG. 35 is a diagram illustrating a modification example of the planar configuration of part (B) of FIG. 31.

FIG. 36 is a diagram illustrating a modification example of the perspective configuration of the first tab of FIG. 30.

FIG. 37 is a diagram illustrating a sectional configuration example of the first tab of FIG. 36.

FIG. 38 is a diagram illustrating a modification example of the perspective configuration of the first tab of FIG. 30.

FIG. 39 is a diagram illustrating a sectional configuration example of the first tab of FIG. 38.

FIG. 40 is a diagram illustrating a perspective configuration example of a battery pack according to a third embodiment of the present technology.

FIG. 41 is a diagram illustrating a perspective configuration example of components housed in the battery pack.

FIG. 42 is a diagram illustrating an exploded perspective configuration example of the battery pack.

FIG. 43 is a diagram illustrating an example of the arrangement of the multiple batteries in the battery unit.

FIG. 44 is a diagram illustrating an exploded perspective configuration example of a first tab.

Part (A) of FIG. 45 is a diagram illustrating a planar configuration example of the first tab of FIG. 44, and part (B) of FIG. 45 is a diagram illustrating a configuration example in which a planar configuration of the batteries and a heat-absorbing member is superimposed on the planar configuration of part (A) of FIG. 45.

FIG. 46 is a diagram illustrating a sectional configuration example of part (A) of FIG. 45 taken along line A-A.

FIG. 47 is a diagram illustrating a perspective configuration example of a second tab.

Part (A) of FIG. 48 is a diagram illustrating a planar configuration example of the second tab of FIG. 47, and part (B) of FIG. 48 is a diagram illustrating a configuration example in which a planar configuration of the batteries and the heat-absorbing member is superimposed on the planar configuration of part (A) of FIG. 48.

FIG. 49 is a diagram illustrating a sectional configuration example of part (A) of FIG. 48 taken along line A-A.

FIG. 50 is a diagram illustrating a modification example of the planar configuration of part (B) of FIG. 45.

FIG. 51 is a diagram illustrating a modification example of the planar configuration of part (B) of FIG. 48.

FIG. 52 is a diagram illustrating a modification example of the perspective configuration of the first tab of FIG. 44.

FIG. 53 is a diagram illustrating a modification example of the perspective configuration of the second tab of FIG. 47.

FIG. 54 is a diagram illustrating a perspective configuration example of a battery pack according to a fourth embodiment of the present technology.

FIG. 55 is a diagram illustrating a perspective configuration example of components housed in the battery pack.

FIG. 56 is a diagram illustrating an exploded perspective configuration example of the battery pack.

FIG. 57 is a diagram illustrating an example of the arrangement of the multiple batteries in the battery unit.

FIG. 58 is a diagram illustrating an exploded perspective configuration example of a first tab.

FIG. 59 is a diagram illustrating a planar configuration example of the first tab of FIG. 58.

FIG. 60 is a diagram illustrating a configuration example in which a planar configuration of the batteries and heat-absorbing members is superimposed on the planar configuration of FIG. 59.

FIG. 61 is a diagram illustrating a sectional configuration example of FIG. 59 taken along line A-A.

FIG. 62 is a diagram illustrating an exploded perspective configuration example of a second tab.

FIG. 63 is a diagram illustrating a planar configuration example of the second tab of FIG. 62.

FIG. 64 is a diagram illustrating a configuration example in which a planar configuration of the batteries and the heat-absorbing members is superimposed on the planar configuration of FIG. 63.

FIG. 65 is a diagram illustrating a sectional configuration example of FIG. 63 taken along line A-A.

FIG. 66 is a diagram illustrating a modification example of the planar configuration of FIG. 60.

FIG. 67 is a diagram illustrating a modification example of the planar configuration of FIG. 63.

FIG. 68 is a diagram illustrating a modification example of the exploded perspective configuration of the first tab of FIG. 58.

FIG. 69 is a diagram illustrating a modification example of the exploded perspective configuration of the second tab of FIG. 62.

FIG. 70 is a diagram illustrating a modification example of the arrangement of the multiple batteries in the battery unit according to an embodiment.

FIG. 71 is a diagram illustrating a modification example of the arrangement of the multiple batteries in the battery unit according to an embodiment.

FIG. 72 is a diagram illustrating a modification example of the arrangement of the multiple batteries in the battery unit according to an embodiment.

FIG. 73 is a diagram illustrating a modification example of the arrangement of the multiple batteries in the battery unit according to tan embodiment.

FIG. 74 is a diagram illustrating a modification example of the arrangement of the multiple batteries in the battery unit according to an embodiment.

FIG. 75 is a diagram illustrating a modification example of the arrangement of the multiple batteries in the battery unit according to an embodiment.

### DETAILED DESCRIPTION

The present technology is described below in further detail including with reference to the drawings according to an embodiment.

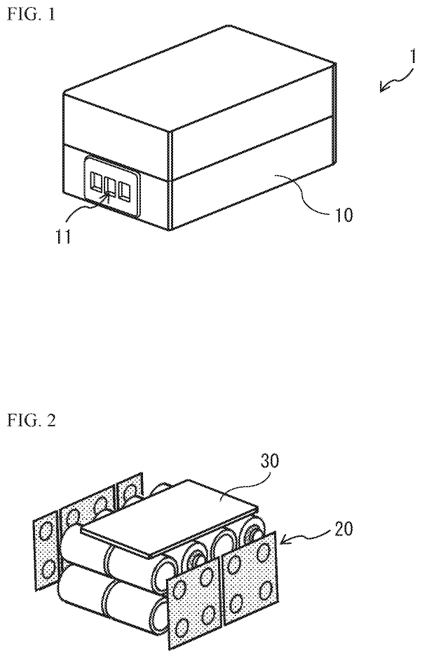

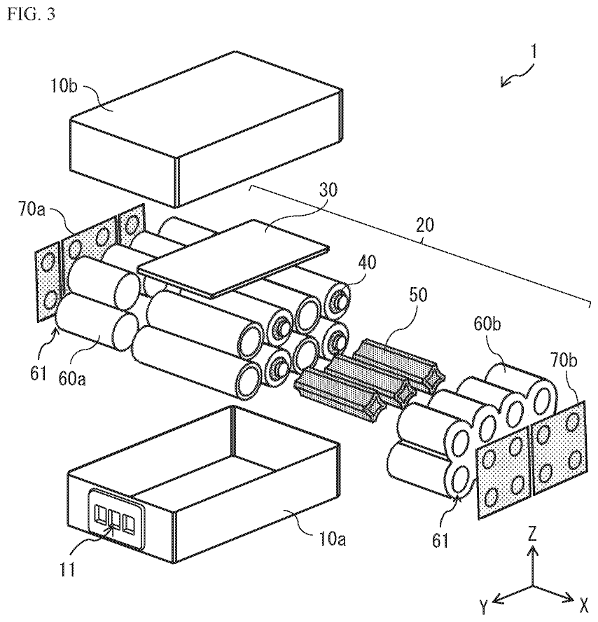

A description is given first of a battery pack 1 according to a first embodiment of the present technology. FIG. 1 illustrates a perspective configuration example of the battery pack 1. FIG. 2 illustrates a perspective configuration example of components housed in the battery pack 1. FIG. 3 illustrates an exploded perspective configuration example of the battery pack 1.

As illustrated in FIGS. 1 and 2, the battery pack 1 includes, for example, an outer casing 10, a battery unit 20 housed in the outer casing 10, and a control board 30. The control board 30 is, for example, coupled to positive and negative electrode terminals of the battery unit 20, and includes a circuit that performs operations such as measuring a voltage of batteries or the battery unit, detecting a remaining capacity of the battery unit, and detecting presence or absence of an overcurrent by measuring a current outputted from the battery unit.

The outer casing 10 includes a lower casing 10a and an upper casing 10b, for example, as illustrated in FIG. 3. The lower casing 10a and the upper casing 10b are stacked on each other to provide a housing space that houses the battery unit 20 and the control board 30. The outer casing 10 (for example, the lower casing 10a) is provided with an external terminal 11 coupled to the control board 30. The battery unit 20 is coupled to the external terminal 11 via the control board 30.

The battery unit 20 includes multiple batteries 40 and two tabs, a tab 70a and a tab 70b. The multiple batteries 40 are so disposed that respective axial directions of the batteries 40 face in the same direction (for example, an X direction in FIG. 3). The two tabs 70a and 70b are disposed to be opposed to each other with the multiple batteries 40 interposed therebetween. The tab 70a is disposed on one end side of each of the batteries 40, and the tab 70b is disposed on another end side of each of the batteries 40. The multiple batteries 40 are electrically coupled to each other via the two tabs 70a and 70b. For example, two or more, but not all, of the multiple batteries 40 are coupled in series to each other by the two tabs 70a and 70b. Further, where the batteries 40 coupled in series to each other are referred to as a series unit, multiple series units are coupled in parallel to each other by the two tabs 70a and 70b. Note that how the multiple batteries 40 are coupled to each other is not limited to the above. A specific configuration of each of the tabs 70a and 70b will be described in detail later.

Each of the batteries 40 is a cylindrical battery. Each of the batteries 40 is a primary battery or a secondary battery. When each of the batteries 40 is a secondary battery, the secondary battery is not particularly limited in kind, but is specifically, for example, a lithium-ion secondary battery in which a battery capacity is obtainable through insertion and extraction of lithium ions. Hereinafter, a case in which each of the batteries 40 is a secondary battery (a lithium-ion secondary battery) will be described. In other words, the battery pack 1 described below is a power source including multiple secondary batteries. The number of the batteries 40 included in the battery unit 20 is 2×n (n is an integer of two or more).

The battery unit 20 further includes multiple heat-absorbing members 50 and a battery holder 60. The multiple heat-absorbing members 50 each extend in the axial direction of the batteries 40. The battery holder 60 holds the (2×n)-number of batteries 40 in layered form. The multiple heat-absorbing members 50 are disposed in the battery holder 60. The number of the heat-absorbing members 50 is n−1. The (n−1)-number of heat-absorbing members 50 are each disposed in corresponding one of (n−1)-number of gaps each surrounded by four batteries 40, out of the (2×n)-number of batteries 40, that are adjacent to each other. A specific configuration of the heat-absorbing member 50 will be described in detail later.

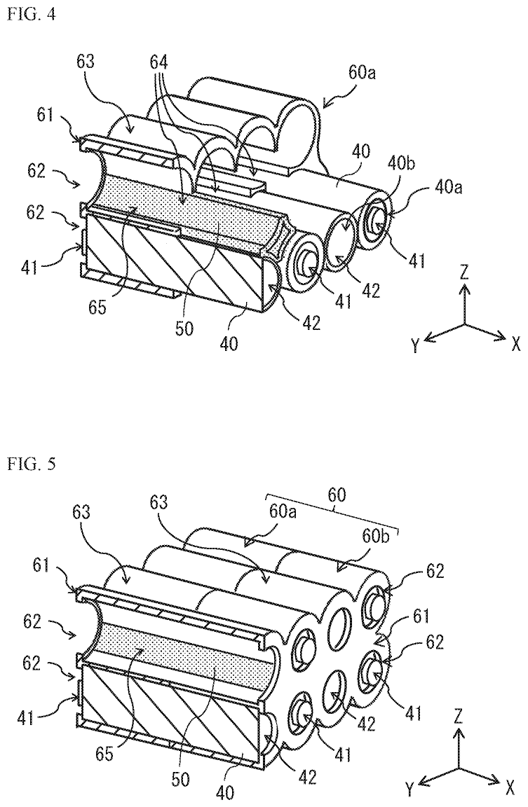

FIG. 4 illustrates a sectional configuration example of the battery holder 60. FIG. 5 illustrates a perspective configuration example of an outer appearance of the battery holder 60. The battery holder 60 includes a pair of holders 60a and 60b, for example, as illustrated in FIGS. 3 to 5. The holders 60a and 60b have a common structure.

Each of the holders 60a and 60b includes a side plate part 61, for example, as illustrated in FIGS. 4 and 5. The side plate part 61 of the holder 60a and the side plate part 61 of the holder 60b are disposed to be opposed to each other with the multiple batteries 40 interposed therebetween in an extending direction of each of the batteries 40 (a direction in which a positive electrode terminal 41 and a negative electrode terminal 42 to be described later are opposed to each other). In the holders 60a and 60b, the side plate parts 61 have openings 62 at locations opposed to the positive electrode terminals 41 and the negative electrode terminals 42 of the batteries 40. Thus, the positive electrode terminal 41 or the negative electrode terminal 42 is exposed in each of the openings 62. Further, when the battery unit 20 is viewed in the axial direction of the batteries 40, the side plate part 61 covers one end of each of the heat-absorbing members 50, and also covers a location, of one end of each of the batteries 40, excluding at least a part of the positive electrode terminal 41 and a part of the negative electrode terminal 42. Specifically, the side plate part 61 covers a portion, of a first end face 40a and a second end face 40b of each of the batteries 40, excluding the positive electrode terminal 41 and the negative electrode terminal 42. Note that as long as the positive electrode terminal 41 and the negative electrode terminal 42 are electrically couplable to the tabs 70a and 70b, a part of the positive electrode terminal 41 and a part of the negative electrode terminal 42 may be covered with the side plate part 61.

Each of the holders 60a and 60b further includes a support part 63 that supports the multiple batteries 40 in layered form with predetermined gaps therebetween, for example, as illustrated in FIG. 5. The term “layered form” refers to a state in which two or more assemblies each including multiple batteries 40 arranged on a predetermined plane (an XY plane) are stacked in a direction perpendicular to the predetermined plane (the XY plane). The side plate part 61 is coupled to each of two opposite end parts of the support parts 63 as a whole. The support parts 63 support multiple cylindrical batteries 40 in layered form with the predetermined gaps therebetween. The support parts 63 have openings 64 at locations surrounded by four cylindrical batteries 40 adjacent to each other. The locations at which the support parts 63 have the openings 64 (the locations surrounded by four cylindrical batteries 40 adjacent to each other) each serve as a housing part 65 that houses the battery 40. The number of the housing parts 65 is n−1.

The (n−1)-number of heat-absorbing members 50 are each disposed in corresponding one of (n−1)-number of gaps (the housing parts 65) each surrounded by four batteries 40, out of the (2×n)-number of batteries 40, that are adjacent to each other. Each of the heat-absorbing members 50 is in contact with outer peripheral surfaces of the four batteries 40 through the opening 64. Each of the openings 64 is in contact with the side plate part 61 of the holder 60a and the side plate part 61 of the holder 60b. Each of the heat-absorbing members 50 is in contact with the side plate part 61 of the holder 60a and the side plate part 61 of the holder 60b through the opening 64.

The battery 40 has the first end face 40a and the second end face 40b that are opposed to each other, the positive electrode terminal 41 provided on the first end face 40a, and the negative electrode terminal 42 provided on the second end face 40b. The battery 40 have, for example, a cylindrical shape extending in a direction in which the first end face 40a and the second end face 40b are opposed to each other, and the first end face 40a and the second end face 40b each have a circular shape. The positive electrode terminal 41 and the negative electrode terminal 42 each include a metal member.

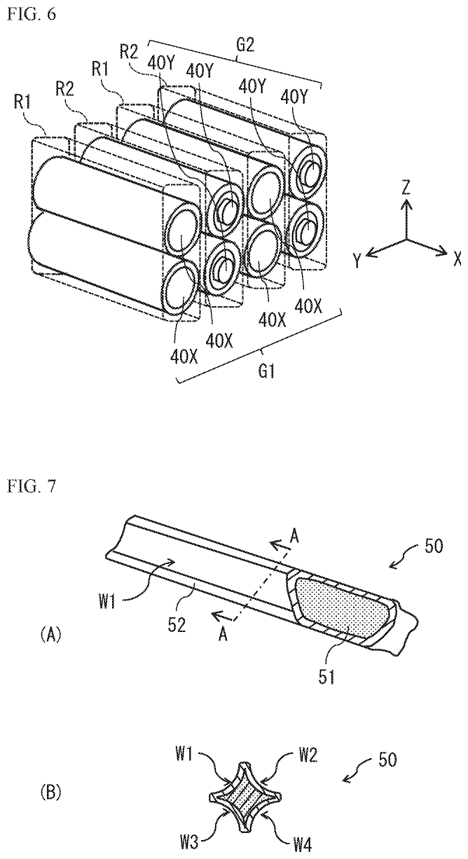

FIG. 6 illustrates an example of an arrangement of (2×n)-number of batteries 40 held by the battery holder 60 when n=4. Each of the batteries 40 held by the battery holder 60 belongs to any one of two groups (a first group G1 or a second group G2). The first group G1 and the second group G2 are concepts that classify the (2×n)-number of batteries 40 in accordance with directions of the batteries 40.

Out of the (2×n)-number of batteries 40 held by the battery holder 60, n-number of batteries 40X (first batteries) belong to the first group G1. Each of the batteries 40X belonging to the first group G1 is so held by the battery holder 60 that the positive electrode terminal 41 is on a side of the tab 70a in an axial direction of the batteries 40X. Out of the (2×n)-number of batteries 40 held by the battery holder 60, n-number of batteries 40Y (second batteries) that are different from the n-number of batteries 40X belong to the second group G2. Each of the batteries 40Y belonging to the second group G2 is so held by the battery holder 60 that the positive electrode terminal 41 is on a side of the tab 70b in an axial direction of the batteries 40Y.

Each of the batteries 40X belonging to the first group G1 is disposed in any one of region R1 out of multiple regions R1 that are spatially separated from each other. Each of the batteries 40Y belonging to the second group G2 is disposed in any one of region R2 out of multiple regions R2 that are spatially separated from each other. The multiple regions R1 and the multiple regions R2 are alternately disposed in a first direction (a Y direction in FIG. 6) orthogonal to the axial direction (the X direction in FIG. 6) of the batteries 40. Each of the regions R1 extends over layers of multiple batteries 40 disposed in layered form within the battery holder 60, in a second direction (a direction in FIG. 6) orthogonal to both the axial direction of the batteries 40 (the X direction in FIG. 6) and the first direction (the Y direction in FIG. 6). Each of the regions R2 extends over layers of multiple batteries 40 disposed in layered form within the battery holder 60, in the second direction (the Z direction in FIG. 6) orthogonal to both the axial direction of the batteries 40 (the X direction in FIG. 6) and the first direction (the Y direction in FIG. 6).

In each of the layers of the multiple batteries 40 disposed in layered form within the battery holder 60, the multiple batteries 40X and the multiple batteries 40Y are alternately disposed one by one in the first direction (the Y direction in FIG. 6) orthogonal to the axial direction of the batteries 40 (the X direction in FIG. 6). The n-number of batteries 40X are arranged in the second direction (the Z direction in FIG. 6) orthogonal to both the axial direction of the batteries 40 (the X direction in FIG. 6) and the first direction (the Y direction in FIG. 6). The n-number of batteries 40Y are arranged in the second direction (the Z direction in FIG. 6) orthogonal to both the axial direction of the batteries 40 (the X direction in FIG. 6) and the first direction (the Y direction in FIG. 6).

Part (A) of FIG. 7 illustrates a perspective configuration example of the heat-absorbing member 50. Part (B) of FIG. 7 illustrates a sectional configuration example of the heat-absorbing member 50 taken along line A-A. The heat-absorbing member 50 has a shape corresponding to a shape of the housing part 65. Similarly to each of the batteries 40, the heat-absorbing member 50 has an elongated columnar shape. The heat-absorbing member 50 is in contact with surfaces (the outer peripheral surfaces) of four cylindrical batteries 40 adjacent to each other, and has, for example, a shape corresponding to a shape of the gap between the four cylindrical batteries 40 adjacent to each other. A section, of the heat-absorbing member 50, in a direction perpendicular to an extending direction of the heat-absorbing member 50 has a substantially rhombic shape, for example, as illustrated in part (B) of FIG. 7. The extending direction of the heat-absorbing module 50 is a direction parallel to the extending direction of each of the batteries 40 (the direction in which the positive electrode terminal 41 and the negative electrode terminal 42 are opposed to each other).

Here, four cylindrical batteries 40 adjacent to each other are referred to as a first battery, a second battery, a third battery, and a fourth battery. In this case, the heat-absorbing member 50 has an arc wall W1 extending along an outer peripheral surface of the first battery, an arc wall W2 extending along an outer peripheral surface of the second battery, an arc wall W3 extending along an outer peripheral surface of the third battery, and an arc wall W4 extending along an outer peripheral surface of the fourth battery. The four arc walls W1 to W4 each have a concave shape conforming to the outer peripheral surface of the battery 40.

The heat-absorbing member 50 includes a heat-absorbing agent 51 and a housing body 52 covering the heat-absorbing agent 51, for example, as illustrated in part (A) and part (B) of FIG. 7.

The heat-absorbing agent 51 includes, for example, a liquid including water, or a hydrogel. When using the hydrogel as the heat-absorbing agent 51, it is preferable to use a synthetic polymer gel. Examples of a material of the synthetic polymer gel include sodium polyacrylate (PNaAA), polyvinyl alcohol (PVA), polyhydroxyethyl methacrylate (PHE-MA), and silicone hydrogel.

The housing body 52 covers the heat-absorbing agent 51. The housing body 52 is formed by, for example, heating and shaping the heat-absorbing agent 51 and a resin layer in a state where the heat-absorbing agent 51 is covered with the resin layer. The housing body 52 may include a flexible sheet member including a thermoplastic material. The housing body 52 includes, for example, a resin layer as the flexible sheet member. The resin layer includes, for example, a resin material such as polyethylene, polystyrene, polypropylene, or polycarbonate. The housing body 52 may include, for example, a stacked film. The stacked film is, for example, a stacked sheet in which a metal layer is sandwiched by two resin layers. In this case, the housing body 52 includes the two resin layers as the flexible sheet member. Each of the resin layers includes, for example, a resin material such as polyethylene, polystyrene, polypropylene, or polycarbonate. The metal layer includes, for example, a metal foil such as an aluminum foil.

Next, a specific configuration of each of the tabs 70a and 70b will be described in detail.

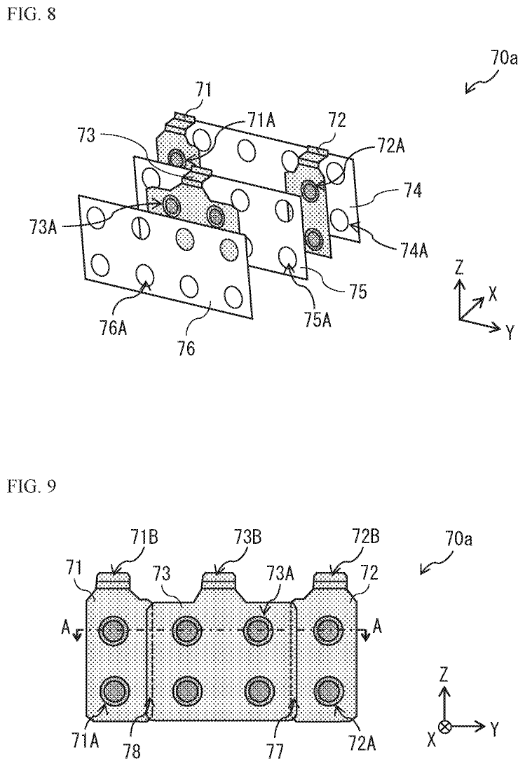

FIG. 8 illustrates an exploded perspective configuration example of the tab 70a. The tab 70a is a tab (a first tab) coupled to a terminal on one end side of each of the (2×n)-number of batteries 40. The tab 70a is a tab module including power extraction tab parts 71 and 72 and an intermediate coupling tab part 73, for example, as illustrated in FIG. 8. The power extraction tab parts 71 and 72 and the intermediate coupling tab part 73 each include a metal member.

The power extraction tab part 72 is coupled to the respective positive electrode terminals 41 of the multiple batteries 40X (third batteries) that are two or more, but not all, of the n-number of batteries 40X belonging to the first group G1. The multiple batteries 40X coupled to the power extraction tab part 72 are disposed in the region R1. The power extraction tab part 72 includes multiple projecting parts 72A protruding toward the batteries 40. The multiple projecting parts 72A are provided at positions opposed to the positive electrode terminals 41 of the multiple batteries 40X disposed in the region R1. Each of the projecting part 72A is electrically coupled to the corresponding one of the positive electrode terminals 41 via an electrically conductive material such as solder.

The power extraction tab part 71 is coupled to the respective negative electrode terminals 42 of the multiple batteries 40Y (fourth batteries) that are two or more, but not all, of the n-number of batteries 40Y belonging to the second group G2. The multiple batteries 40Y coupled to the power extraction tab part 71 are disposed in the region R2. The power extraction tab part 71 includes multiple projecting parts 71A protruding toward the batteries 40. The multiple projecting parts 71A are provided at positions opposed to the negative electrode terminals 42 of the multiple batteries 40Y disposed in the region R2. Each of the projecting part 71A is electrically coupled to the corresponding one of the negative electrode terminals 42 via an electrically conductive material such as solder.

The intermediate coupling tab part 73 is coupled to the respective positive electrode terminals 41 of the multiple batteries 40X (fifth batteries), out of the n-number of batteries 40X belonging to the first group G1, that are other than the multiple third batteries. The intermediate coupling tab part 73 is further coupled to the respective negative electrode terminals 42 of the multiple batteries 40Y (sixth batteries), out of the n-number of batteries 40Y belonging to the second group G2, that are other than the multiple fourth batteries. The intermediate coupling tab part 73 includes multiple projecting parts 73A protruding toward the batteries 40. The multiple projecting parts 73A are provided at positions opposed to the positive electrode terminals 41 of the multiple batteries 40X disposed in the region R1, and at positions opposed to the negative electrode terminals 42 of the multiple batteries 40Y disposed in the region R2. Out of the multiple projecting parts 73A, each of the projecting parts 73A provided at positions opposed to the positive electrode terminals 41 is electrically coupled to the corresponding one of the positive electrode terminals 41 via an electrically conductive material such as solder. Out of the multiple projecting parts 73A, each of the projecting parts 73A provided at positions opposed to the negative electrode terminals 42 is electrically coupled to the corresponding one of the negative electrode terminals 42 via an electrically conductive material such as solder.

The tab 70a further includes insulating layers 74, 75, and 76, for example, as illustrated in FIG. 8. The insulating layer 74 is interposed between: both the power extraction tab parts 71 and 72; and the multiple batteries 40. The insulating layer 74 has multiple openings 74A at positions opposed to the multiple projecting parts 71A, the multiple projecting parts 72A, and the multiple projecting parts 73A. The power extraction tab part 71 is electrically coupled to the respective negative electrode terminals 42 of the multiple batteries 40Y that are opposed to the power extraction tab part 71, through the multiple openings 74A of the insulating layer 74. The power extraction tab part 72 is electrically coupled to the respective positive electrode terminals 41 of the multiple batteries 40X that are opposed to the power extraction tab part 72, through the multiple openings 74A of the insulating layer 74.

The insulating layer 75 is interposed between: both the power extraction tab parts 71 and 72; and the intermediate coupling tab part 73. The insulating layer 75 is configured to electrically insulate the power extraction tab parts 71 and 72 from the intermediate coupling tab part 73. The insulating layer 75 has multiple openings 75A at positions opposed to at least the multiple projecting parts 73A, out of the multiple projecting parts 71A, the multiple projecting parts 72A, and the multiple projecting parts 73A. FIG. 8 illustrates an example of a state in which the insulating layer 75 has the multiple openings 75A at positions opposed to the multiple projecting parts 71A, the multiple projecting parts 72A, and the multiple projecting parts 73A. The intermediate coupling tab part 73 is electrically coupled to the respective positive electrode terminals 41 of the multiple batteries 40X and the respective negative electrode terminals 42 of the multiple batteries 40Y that are opposed to the intermediate coupling tab part 73, through the multiple openings 74A of the insulating layer 74 and the multiple openings 75A of the insulating layer 75.

The insulating layer 76 is interposed between the intermediate coupling tab part 73 and an inner wall of the outer casing 10. The insulating layer 76 may have multiple openings 76A at positions opposed to the multiple projecting parts 71A, the multiple projecting parts 72A, and the multiple projecting parts 73A, for example, as illustrated in FIG. 8. The insulating layer 76 having the openings 76A improves workability when coupling the projecting parts (the projecting parts 71A, 72A, and 73A) of the tab parts (the power extraction tab parts 71 and 72 and the intermediate coupling tab part 73) to the respective batteries 40 provided at positions opposed to the projecting parts 71A, 72A, and 73A. The insulating layer 76 may include, for example, a sheet having no opening. The insulating layers 75 and 76 may have, for example, the same configuration as the insulating layer 74. The insulating layers 74, 75, and 76 each include, for example, a resin sheet. The insulating layers 74, 75, and 76 are bonded to each other by, for example, thermal-fusion-bonding the resin sheets, and serve to fix a relative positional relationship between the power extraction tab parts 71 and 72 and the intermediate coupling tab part 73.

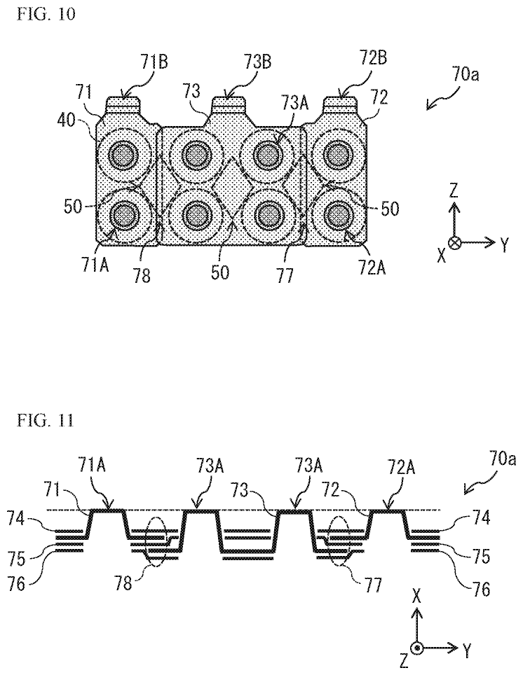

FIG. 9 illustrates a planar configuration example of the power extraction tab parts 71 and 72 and the intermediate coupling tab part 73 included in the tab 70a. In the tab 70a, a part of the power extraction tab part 71 and a part of the intermediate coupling tab part 73 overlap each other. That is, the tab 70a includes an overlap part 78 in which the power extraction tab part 71 and the intermediate coupling tab part 73 overlap each other. The overlap part 78 is disposed at a position opposed to the heat-absorbing member 50 that is provided between the multiple batteries 40 coupled to the power extraction tab part 71 and the multiple batteries 40 coupled to the intermediate coupling tab part 73 and positioned closer to the power extraction tab part 71, for example, as illustrated in FIG. 10. In the tab 70a, a part of the power extraction tab part 72 and a part of the intermediate coupling tab part 73 overlap each other. That is, the tab 70a includes an overlap part 77 in which the power extraction tab part 72 and the intermediate coupling tab part 73 overlap each other. The overlap part 77 is disposed at a position opposed to the heat-absorbing member 50 that is provided between the multiple batteries 40 coupled to the power extraction tab part 72 and the multiple batteries 40 coupled to the intermediate coupling tab part 73 and positioned closer to the power extraction tab part 72, for example, as illustrated in FIG. 10. The tab 70a is (specifically, the power extraction tab parts 71 and 72 and the intermediate coupling tab part 73 are) provided to cover, when the battery unit 20 is viewed in the axial direction of the batteries 40, one end of each of the heat-absorbing members 50 and one end of each of the batteries 40, for example, as illustrated in FIG. 10.

FIG. 11 illustrates a sectional configuration example of FIG. 9 taken along line A-A. The insulating layers 74 and 75 are provided to sandwich portions, of the power extraction tab parts 71 and 72, excluding the projecting parts 71A and 72A, for example, as illustrated in FIG. 11. The insulating layers 75 and 76 are provided to sandwich a portion, of the intermediate coupling tab part 73, excluding the projecting parts 73A, for example, as illustrated in FIG. 11. In the tab 70a, respective top parts of the projecting parts 71A, respective top parts of the projecting parts 72A, and respective top parts of the projecting parts 73A are disposed in the same plane.

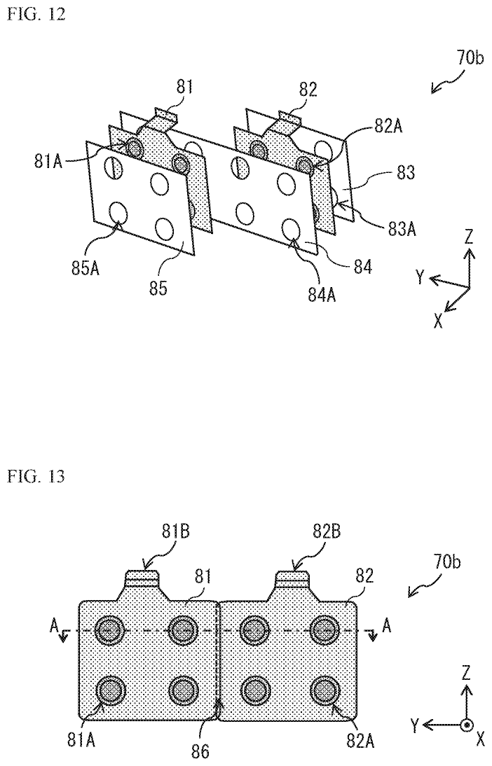

FIG. 12 illustrates an exploded perspective configuration example of the tab 70b. The tab 70b is a tab (a second tab) coupled to a terminal on another end side of each of the (2×n)-number of batteries 40. The tab 70b is a tab module including intermediate coupling tab parts 81 and 82, for example, as illustrated in FIG. 12. The intermediate coupling tab parts 81 and 82 each include a metal member.

The intermediate coupling tab part 81 is coupled to the respective negative electrode terminal 42 of the multiple batteries 40X (the third batteries) that are two or more, but not all, of the n-number of batteries 40X belonging to the first group G1. The intermediate coupling tab part 81 is further coupled to the respective positive electrode terminals 41 of the multiple batteries 40Y (the sixth batteries), out of the n-number of batteries 40Y belonging to the second group G2, that are other than the multiple fourth batteries. The intermediate coupling tab part 81 includes multiple projecting parts 81A protruding toward the batteries 40. The multiple projecting parts 81A are provided at positions opposed to the negative electrode terminals 42 of the multiple batteries 40X disposed in the region R1, and at positions opposed to the positive electrode terminals 41 of the multiple batteries 40Y disposed in the region R2. Out of the multiple projecting parts 81A, each of the projecting parts 81A provided at positions opposed to the negative electrode terminals 42 is electrically coupled to the corresponding one of the negative electrode terminals 42 via an electrically conductive material such as solder. Out of the multiple projecting parts 81A, each of the projecting parts 81A provided at positions opposed to the positive electrode terminals 41 is electrically coupled to the corresponding one of the positive electrode terminals 41 via an electrically conductive material such as solder.

The intermediate coupling tab part 82 is coupled to the respective positive electrode terminal 41 of the multiple batteries 40Y (the fourth batteries) that are two or more, but not all, of the n-number of batteries 40Y belonging to the second group G2. The intermediate coupling tab part 82 is further coupled to the respective negative electrode terminals 42 of the multiple batteries 40Y (the fifth batteries), out of the n-number of batteries 40Y belonging to the second group G2, that are other than the multiple third batteries. The intermediate coupling tab part 82 includes multiple projecting parts 82A protruding toward the batteries 40. The multiple projecting parts 82A are provided at positions opposed to the negative electrode terminals 42 of the multiple batteries 40X disposed in the region R1, and at positions opposed to the positive electrode terminals 41 of the multiple batteries 40Y disposed in the region R2. Out of the multiple projecting parts 82A, each of the projecting parts 82A provided at positions opposed to the negative electrode terminals 42 is electrically coupled to the corresponding one of the negative electrode terminals 42 via an electrically conductive material such as solder. Out of the multiple projecting parts 82A, each of the projecting parts 82A provided at positions opposed to the positive electrode terminals 41 is electrically coupled to the corresponding one of the positive electrode terminals 41 via an electrically conductive material such as solder.

The tab 70b further includes insulating layers 83, 84, and 85, for example, as illustrated in FIG. 12. The insulating layer 83 is interposed between the intermediate coupling tab part 82 and the multiple batteries 40. The insulating layer 83 has multiple openings 83A at positions opposed to the multiple projecting parts 82A. The intermediate coupling tab part 82 is electrically coupled to the respective negative electrode terminals 42 of the multiple batteries 40X and the respective positive electrode terminals 41 of the multiple batteries 40Y that are opposed to the intermediate coupling tab part 82, through the multiple openings 83A of the insulating layer 83.

The insulating layer 84 is interposed between the intermediate coupling tab part 81 and the intermediate coupling tab part 82. The insulating layer 84 is configured to electrically insulate the intermediate coupling tab part 81 and the intermediate coupling tab part 82 from each other. The insulating layer 84 has multiple openings 84A at positions opposed to at least the multiple projecting parts 81A, out of the multiple projecting parts 81A and the multiple projecting parts 82A. FIG. 11 illustrates an example of a state in which the insulating layer 84 has the multiple openings 84A at positions opposed to the multiple projecting parts 81A and the multiple projecting parts 82A. The intermediate coupling tab part 81 is electrically coupled to the respective negative electrode terminals 42 of the multiple batteries 40X and the respective positive electrode terminals 41 of the multiple batteries 40Y that are opposed to the intermediate coupling tab part 81, through the multiple openings 84A of the insulating layer 84.

The insulating layer 85 is interposed between the intermediate coupling tab part 81 and the inner wall of the outer casing 10. The insulating layer 85 may have multiple openings 85A at positions opposed to the multiple projecting parts 81A, for example, as illustrated in FIG. 12. The insulating layer 85 having the openings 85A improves workability when coupling the projecting parts (the projecting parts 81A and 82A) of the tab parts (the intermediate coupling tab parts 81 and 82) to the respective batteries 40 provided at positions opposed to the projecting parts 81A and 82A. The insulating layer 85 may include, for example, a sheet having no opening. The insulating layers 83, 84, and 85 each include, for example, a resin sheet. The insulating layers 83, 84, and 85 are bonded to each other by, for example, thermal-fusion-bonding the resin sheets, and serve to fix a relative positional relationship between the intermediate coupling tab parts 81 and 82.

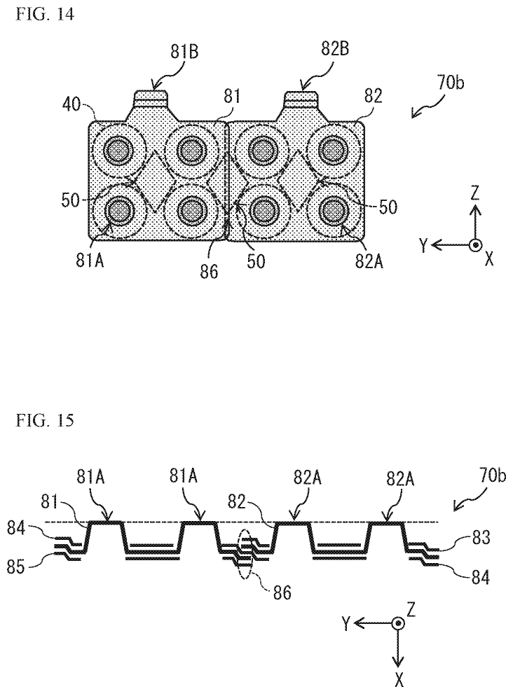

FIG. 13 illustrates a planar configuration example of the intermediate coupling tab parts 81 and 82 included in the tab 70b. In the tab 70b, a part of the intermediate coupling tab part 81 and a part of the intermediate coupling tab part 82 overlap each other. That is, the tab 70b includes an overlap part 86 in which the intermediate coupling tab part 81 and the intermediate coupling tab part 82 overlap each other. The overlap part 86 is disposed at a position opposed to the heat-absorbing member 50 that is provided between the multiple batteries 40 coupled to the intermediate coupling tab part 81 and positioned closer to the intermediate coupling tab part 82 and the multiple batteries 40 coupled to the intermediate coupling tab part 82 and positioned closer to the intermediate coupling tab part 81, for example, as illustrated in FIG. 14. The tab 70b is (specifically, the intermediate coupling tab parts 81 and 82 are) provided to cover, when the battery unit 20 is viewed in the axial direction of the batteries 40, one end of each of the heat-absorbing members 50 and one end of each of the batteries 40, for example, as illustrated in FIG. 14.

FIG. 15 illustrates a sectional configuration example of FIG. 13 taken along line A-A. The insulating layers 83 and 84 are provided to sandwich a portion, of the intermediate coupling tab part 82, excluding the projecting parts 82A, for example, as illustrated in FIG. 15. The insulating layers 84 and 85 are provided to sandwich a portion, of the intermediate coupling tab part 81, excluding the projecting parts 81A, for example, as illustrated in FIG. 15. In the tab 70b, respective top parts of the projecting parts 81A and respective top parts of the projecting parts 82A are disposed in the same plane.

In the tab 70a, the power extraction tab part 71 includes a hook 71B, the power extraction tab part 72 includes a hook 72B, and the intermediate coupling tab part 73 includes a hook 73B, for example, as illustrated in FIG. 9. In the tab 70b, the intermediate coupling tab part 81 includes a hook 81B, and the intermediate coupling tab part 82 includes a hook 82B, for example, as illustrated in FIG. 13. The hooks 71B, 72B, and 73B are each engaged with a slit part 31 of the control board 30. The hooks 71B, 72B, and 73B are thereby each configured to fix the tab 70a to the control board 30. The hooks 81B and 82B are each engaged with the slit part 31 of the control board 30. The hooks 81B and 82B are thereby each configured to fix the tab 70b to the control board 30. Hereinafter, the hooks 71B, 72B, 73B, 81B, and 82B are collectively referred to as a hook FK.

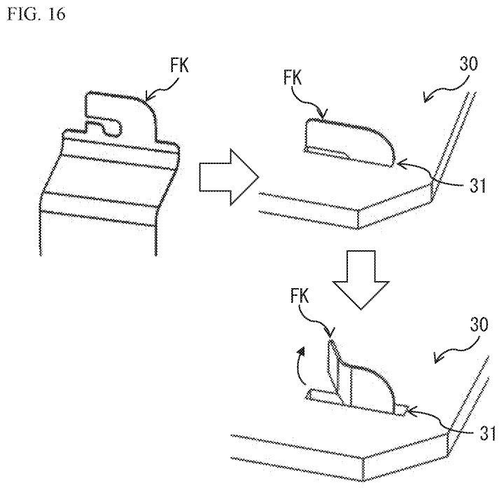

FIG. 16 illustrates a procedure of engaging the hook FK included in each of the tabs 70a and 70b with the control board 30. First, the hook FK is inserted through the slit part 31 of the control board 30. Thereafter, a portion, of the hook FK, that is exposed from the slit part 31 is bent. Thus, the hook FK is engaged with the slit part 31 of the control board 30.

Next, effects of the battery pack 1 will be described.

In the present embodiment, the tab 70a is provided to cover, when the battery unit 20 is viewed in the axial direction of the batteries 40, one end of each of the heat-absorbing members 50. In addition, the tab 70b is provided to cover, when the battery unit 20 is viewed in the axial direction of the batteries 40, another end of each of the heat-absorbing members 50. Accordingly, when the housing body 52 cleaves and the heat-absorbing agent 51 leaks out, the tabs 70a and 70b each operate as a wall, which makes it possible to retain the heat-absorbing agent 51 within the battery unit 20. This makes it possible to suppress a decrease in heat absorption performance with the heat-absorbing agent 51. It is therefore possible to provide the battery pack 1 having a structure exhibiting high heat absorption performance with the heat-absorbing agent 51.

In the present embodiment, the tab 70a is provided to cover, when the battery unit 20 is viewed in the axial direction of the batteries 40, one end of each of the heat-absorbing members 50 and one end of each of the batteries 40. In addition, the tab 70b is provided to cover, when the battery unit 20 is viewed in the axial direction of the batteries 40, another end of each of the heat-absorbing members 50 and another end of each of the batteries 40. Accordingly, when the housing body 52 cleaves and the heat-absorbing agent 51 leaks out, the tabs 70a and 70b each operate as a wall, which makes it possible to retain the heat-absorbing agent 51 within the battery unit 20. This makes it possible to suppress a decrease in heat absorption performance with the heat-absorbing agent 51. It is therefore possible to provide the battery pack 1 having a structure exhibiting high heat absorption performance with the heat-absorbing agent 51.

In the present embodiment, when the battery unit 20 is viewed in the axial direction of the batteries 40, the side plate part 61 of the holder 60a covers one end of each of the heat-absorbing members 50, and also covers a location, of one end of each of the batteries 40, excluding at least a part of the positive electrode terminal 41 and a part of the negative electrode terminal 42. In addition, when the battery unit 20 is viewed in the axial direction of the batteries 40, the side plate part 61 of the holder 60b covers another end of each of the heat-absorbing members 50, and also covers a location, of another end of each of the batteries 40, excluding at least a part of the positive electrode terminal 41 and a part of the negative electrode terminal 42. Accordingly, when the housing body 52 cleaves and the heat-absorbing agent 51 leaks out, the side plate parts 61 each operate as a wall, which makes it possible to retain the heat-absorbing agent 51 within the battery unit 20. This makes it possible to suppress a decrease in heat absorption performance with the heat-absorbing agent 51. It is therefore possible to provide the battery pack 1 having a structure exhibiting high heat absorption performance with the heat-absorbing agent 51.

In the present embodiment, the tab 70a is a tab module including the overlap part 77 in which the power extraction tab part 72 and the intermediate coupling tab part 73 overlap each other, and the overlap part 78 in which the power extraction tab part 71 and the intermediate coupling tab part 73 overlap each other. In addition, the tab 70b is a tab module including the overlap part 86 in which the intermediate coupling tab part 81 and the intermediate coupling tab part 82 overlap each other. The overlap part 77 is disposed at the position opposed to the heat-absorbing member 50 that is provided between the multiple batteries 40 coupled to the power extraction tab part 71 and the multiple batteries 40 coupled to the intermediate coupling tab part 73 and positioned closer to the power extraction tab part 71. The overlap part 78 is disposed at the position opposed to the heat-absorbing member 50 that is provided between the multiple batteries 40 coupled to the power extraction tab part 72 and the multiple batteries 40 coupled to the intermediate coupling tab part 73 and positioned closer to the power extraction tab part 72. The overlap part 86 is disposed at the position opposed to the heat-absorbing member 50 that is provided between the multiple batteries 40 coupled to the intermediate coupling tab part 81 and positioned closer to the intermediate coupling tab part 82 and the multiple batteries 40 coupled to the intermediate coupling tab part 82 and positioned closer to the intermediate coupling tab part 81. Accordingly, when the housing body 52 cleaves and the heat-absorbing agent 51 leaks out, the tab 70a (specifically, the power extraction tab parts 71 and 72 and the intermediate coupling tab part 73) and the tab 70b (specifically, the intermediate coupling tab parts 81 and 82) each operate as a wall, which makes it possible to retain the heat-absorbing agent 51 within the battery unit 20. This makes it possible to suppress a decrease in heat absorption performance with the heat-absorbing agent 51. It is therefore possible to provide the battery pack 1 having a structure exhibiting high heat absorption performance with the heat-absorbing agent 51.

In the present embodiment, the insulating layer 75 is provided that electrically insulates the power extraction tab parts 71 and 72 from the intermediate coupling tab part 73, and the insulating layer 84 is provided that electrically insulates the intermediate coupling tab part 81 from the intermediate coupling tab part 82. This makes it possible to provide the tab 70a as a single-piece part without deteriorating an electrical function of the tab 70a, and to provide the tab 70b as a single-piece part without deteriorating an electrical function of the tab 70b.

In the present embodiment, the tab 70a is provided with the hooks 71B, 72B, and 73B, and the tab 70b is provided with the hooks 81B and 82B. This makes it possible to prevent detachment of the tabs 70a and 70b from the battery unit 20 due to a force of gas discharge during an abnormal event, and to retain the leaked heat-absorbing agent 51.

Next, a description will be given of modification examples of the battery pack 1 according to an embodiment.

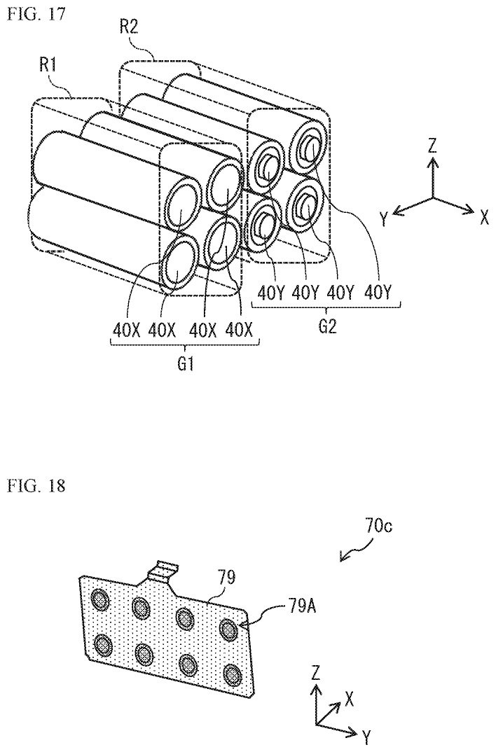

In the first embodiment, for example, as illustrated in FIG. 17, the multiple regions R1 may be integrated into one region R1, and the multiple regions R2 may be integrated into one region R2. In this case, all the batteries 40X in the battery holder 60, i.e., all the batteries 40X belonging to the first group G1, are disposed in the one integrated region R1, and all the batteries 40Y in the battery holder 60, i.e., all the batteries 40Y belonging to the second group G2, are disposed in the one integrated region R2.

In the present modification example, a tab 70c is provided, for example, as illustrated in FIG. 18, instead of the tab 70a. In the present modification example, in the tab 70b, the intermediate coupling tab part 81 is used as a power extraction tab part, and the intermediate coupling tab part 82 is used as a power extraction tab part. The tab 70c is a tab (the first tab) coupled to a terminal on one end side of each of the (2×n)-number of batteries 40. The tab 70c includes a metal member.

The tab 70c is an intermediate coupling tab part 79 coupled to the respective positive electrode terminals 41 of the n-number of batteries 40X belonging to the first group G1 and to the respective negative electrode terminals 42 of the n-number of batteries 40Y belonging to the second group G2. The tab 70a is (specifically, the intermediate coupling tab part 79 are) provided to cover, when the battery unit 20 is viewed in the axial direction of the batteries 40, one end of each of the heat-absorbing members 50 and one end of each of the batteries 40.

The intermediate coupling tab part 79 includes multiple projecting parts 79A protruding toward the batteries 40. The multiple projecting parts 79A are provided at positions opposed to the positive electrode terminals 41 of the n-number of batteries 40X belonging to the first group G1, and at positions opposed to the negative electrode terminals 42 of the n-number of batteries 40Y belonging to the second group G2. Out of the multiple projecting parts 79A, each of the projecting parts 79A provided at positions opposed to the positive electrode terminals 41 is electrically coupled to the corresponding one of the positive electrode terminals 41 via an electrically conductive material such as solder. Out of the multiple projecting parts 79A, each of the projecting parts 79A provided at positions opposed to the negative electrode terminals 42 is electrically coupled to the corresponding one of the negative electrode terminals 42 via an electrically conductive material such as solder.

In the present modification example, a tab 70c is provided, instead of the tab 70a. In this case also, when the housing body 52 cleaves and the heat-absorbing agent 51 leaks out, the tabs 70a and 70c each operate as a wall, which makes it possible to retain the heat-absorbing agent 51 within the battery unit 20. This makes it possible to suppress a decrease in heat absorption performance with the heat-absorbing agent 51. It is therefore possible to provide the battery pack 1 having a structure exhibiting high heat absorption performance with the heat-absorbing agent 51.

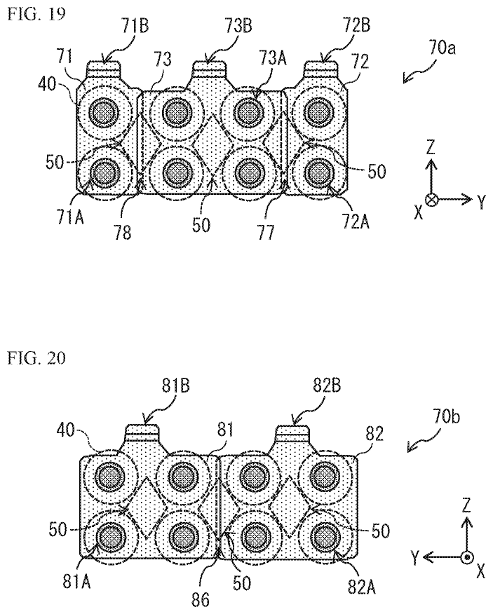

In the first embodiment, when the battery unit 20 is viewed in the axial direction of the batteries 40, the tab 70a (specifically, the power extraction tab parts 71 and 72 and the intermediate coupling tab part 73) may be provided to cover one end of each of the heat-absorbing members 50, and to expose a part of one end of each of the batteries 40, for example, as illustrated in FIG. 19. In the first embodiment, when the battery unit 20 is viewed in the axial direction of the batteries 40, the tab 70b (specifically, the intermediate coupling tab parts 81 and 82) may be provided to cover one end of each of the heat-absorbing members 50, and to expose a part of one end of each of the batteries 40, for example, as illustrated in FIG. 20.

In this case also, when the housing body 52 cleaves and the heat-absorbing agent 51 leaks out, the tabs 70a and 70b each operate as a wall, which makes it possible to retain the heat-absorbing agent 51 within the battery unit 20. This makes it possible to suppress a decrease in heat absorption performance with the heat-absorbing agent 51. It is therefore possible to provide the battery pack 1 having a structure exhibiting high heat absorption performance with the heat-absorbing agent 51.

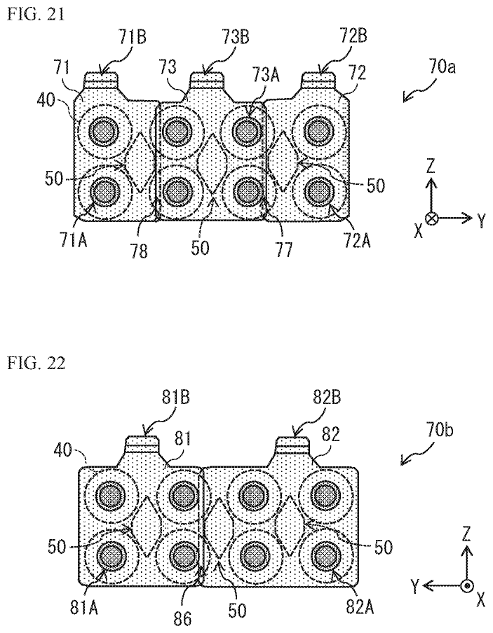

In the first embodiment and Modification example 1-2, each of the overlap parts 77 and 78 may not be disposed at any of respective positions opposed to one end of the heat-absorbing members 50, and may be disposed at corresponding one of respective positions not opposed to the one end of the heat-absorbing members 50, for example, as illustrated in FIG. 21. In the first embodiment and Modification example 1-2, the overlap part 86 may not be disposed at any of respective positions opposed to another end of the heat-absorbing members 50, and may be disposed at corresponding one of respective positions not opposed to the other end of the heat-absorbing members 50, for example, as illustrated in FIG. 22. This makes it possible to suppress a decrease in heat absorption performance with the heat-absorbing agent 51 similarly to the first embodiment and Modification example 1-2 of the first embodiment. It is therefore possible to provide the battery pack 1 having a structure exhibiting high heat absorption performance with the heat-absorbing agent 51.

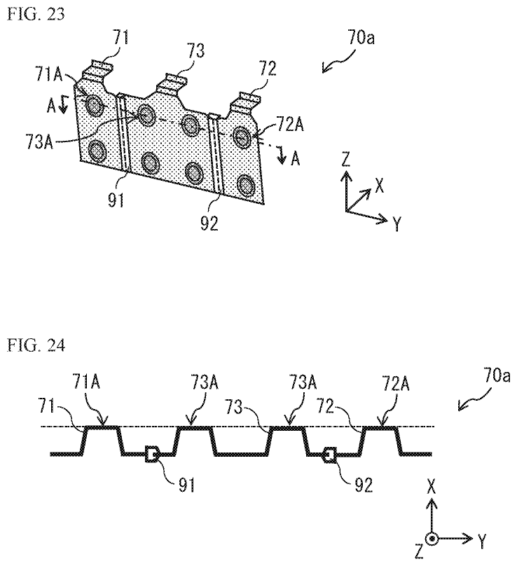

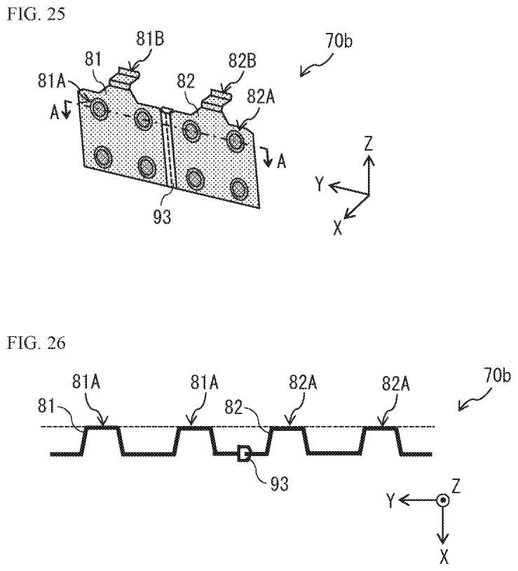

In the first embodiment and Modification examples 1-2 and 1-3, the tab 70a may include the power extraction tab parts 71 and 72 and the intermediate coupling tab part 73 disposed in the same plane, and in addition, may include an insulating layer 91 at a gap between an end part of the power extraction tab part 71 and an end part of the intermediate coupling tab part 73, and an insulating layer 92 at a gap between an end part of the power extraction tab part 72 and an end part of the intermediate coupling tab part 73, for example, as illustrated in FIGS. 23 and 24. In the first embodiment and Modification examples 1-2 and 1-3, the tab 70b may include the intermediate coupling tab parts 81 and 82 disposed in the same plane, and in addition, may include an insulating layer 93 at a gap between an end part of the intermediate coupling tab part 81 and an end part of the intermediate coupling tab part 82, for example, as illustrated in FIGS. 25 and 26.

The insulating layers 91, 92, and 93 each include, for example, a resin material. The insulating layer 91 is provided to couple the end part of the power extraction tab part 71 and the end part of the intermediate coupling tab part 73 to each other. The insulating layer 92 is provided to couple the end part of the power extraction tab part 72 and the end part of the intermediate coupling tab part 73 to each other. The insulating layer 93 is provided to couple the end part of the intermediate coupling tab part 81 and the end part of the intermediate coupling tab part 82 to each other.

In this case also, when the housing body 52 cleaves and the heat-absorbing agent 51 leaks out, the tabs 70a and 70b each operate as a wall, which makes it possible to retain the heat-absorbing agent 51 within the battery unit 20. This makes it possible to suppress a decrease in heat absorption performance with the heat-absorbing agent 51. It is therefore possible to provide the battery pack 1 having a structure exhibiting high heat absorption performance with the heat-absorbing agent 51.

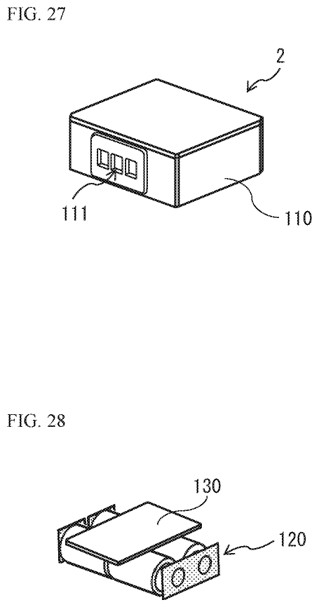

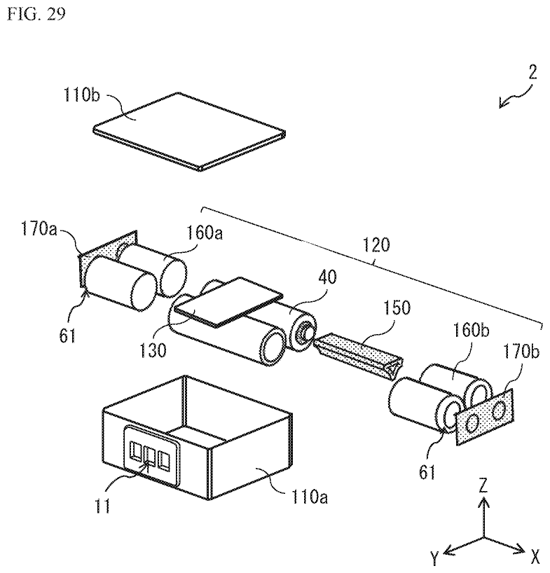

Next, a description will be given of a battery pack 2 according to a second embodiment of the present technology. FIG. 27 illustrates a perspective configuration example of the battery pack 2. FIG. 28 illustrates a perspective configuration example of components housed in the battery pack 2. FIG. 29 is a diagram illustrating an exploded perspective configuration example of the battery pack 2.

As illustrated in FIGS. 27 and 28, the battery pack 2 includes, for example, an outer casing 110, a battery unit 120 housed in the outer casing 110, and a control board 130. The control board 130 is, for example, coupled to positive and negative electrode terminals of the battery unit 120, and includes a circuit that performs operations such as measuring a voltage of batteries or the battery unit, detecting a remaining capacity of the battery unit, and detecting presence or absence of an overcurrent by measuring a current outputted from the battery unit.

The outer casing 110 includes a lower casing 110a and an upper cover 110b, for example, as illustrated in FIG. 29. The lower casing 110a and the upper cover 110b are stacked on each other to form a housing space for housing the battery unit 120 and the control board 130. The outer casing 110 (for example, the lower casing 110a) is provided with an external terminal 111 coupled to the control board 130. The battery unit 120 is coupled to the external terminal 111 via the control board 130.

The battery unit 120 includes two batteries 40 and two tabs, a tab 170a and a tab 170b. The two batteries 40 are so disposed that respective axial directions of the batteries 40 face in the same direction (for example, the X direction in FIG. 29). The two batteries 40 are arranged on the predetermined plane (the XY plane). The two tabs 170a and 170b are disposed to be opposed to each other with the two batteries 40 interposed therebetween. The tab 170a is disposed on one end side of each of the batteries 40, and the tab 170b is disposed on another end side of each of the batteries 40. The two batteries 40 are electrically coupled to each other via the two tabs 170a and 170b. For example, the two batteries 40 are coupled in series to each other via the two tabs 170a and 170b. A specific configuration of each of the tabs 170a and 170b will be described in detail later.

The battery unit 120 further includes one heat-absorbing member 150 and a battery holder 160. The one heat-absorbing member 150 extends in the axial direction of the batteries 40. The battery holder 160 holds the two batteries 40. The one heat-absorbing member 150 is disposed in the battery holder 160. The one heat-absorbing member 150 is disposed in a gap having a triangular prism shape provided between the two batteries 40 adjacent to each other. The heat-absorbing member 150 has a configuration in common with the heat-absorbing member 50 except that the section thereof is substantially triangular.

The battery holder 160 includes a pair of holders 160a and 160b, for example, as illustrated in FIG. 29. The holders 160a and 160b have configurations common with the holders 60a and 60b except that the number of batteries 40 held by the holders 160a and 160b is two.

Next, a specific configuration of each of the tabs 170a and 170b will be described in detail.

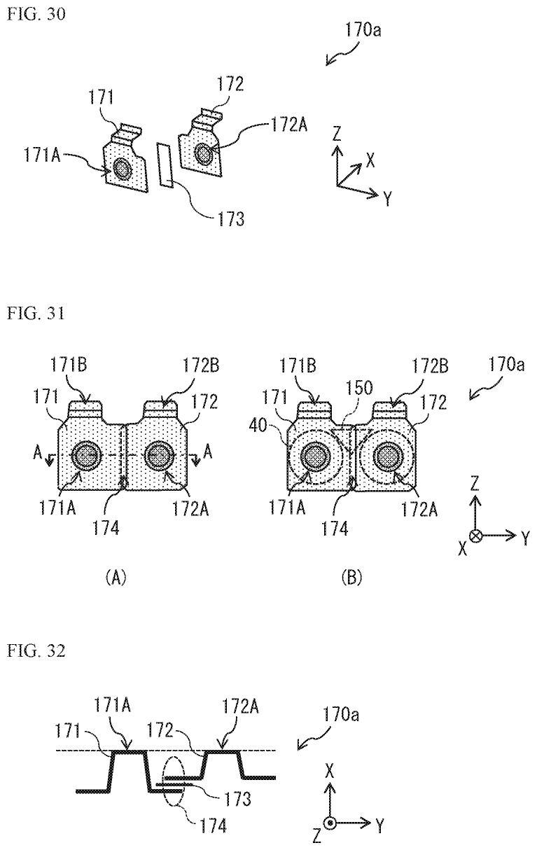

FIG. 30 illustrates an exploded perspective configuration example of the tab 170a. The tab 170a is a tab module including power extraction tab parts 171 and 172, for example, as illustrated in FIG. 30. The power extraction tab parts 171 and 172 each include a metal member.

The power extraction tab part 172 is coupled to the positive electrode terminal 41 of one of the two batteries 40. The power extraction tab part 172 includes a projecting part 172A protruding toward the battery 40. The projecting part 172A is provided at a position opposed to the positive electrode terminal 41 of the one of the two batteries 40. The projecting part 172A is electrically coupled to the positive electrode terminal 41 via an electrically conductive material such as solder.

The power extraction tab part 171 is coupled to the negative electrode terminal 42 of another one of the two batteries 40. The power extraction tab part 171 includes a projecting part 171A protruding toward the battery 40. The projecting part 171A is provided at a position opposed to the negative electrode terminal 42 of the other one of the two batteries 40. The projecting part 171A is electrically coupled to the negative electrode terminal 42 via an electrically conductive material such as solder.

The tab 170a further includes an insulating layer 173, for example, as illustrated in FIG. 30. The insulating layer 173 is disposed between the power extraction tab part 171 and the power extraction tab part 172. The insulating layer 173 includes, for example, a resin sheet having no opening.

Part (A) of FIG. 31 illustrates a planar configuration example of the power extraction tab parts 171 and 172 included in the tab 170a. In the tab 170a, a part of the power extraction tab part 171 and a part of the power extraction tab part 172 overlap each other. That is, the tab 170a includes an overlap part 174 in which the power extraction tab part 171 and the power extraction tab part 172 overlap each other. The overlap part 174 is disposed at a position opposed to the heat-absorbing member 150 that is disposed between the battery 40 coupled to the power extraction tab part 171 and the battery 40 coupled to the power extraction tab part 172, for example, as illustrated in part (B) of FIG. 31. The tab 170a is (specifically, the power extraction tab parts 171 and 172 are) provided to cover, when the battery unit 20 is viewed in the axial direction of the batteries 40, one end of the heat-absorbing member 150 and one end of each of the batteries 40, for example, as illustrated in part (B) of FIG. 31.

FIG. 32 illustrates a sectional configuration example of part (A) of FIG. 31 taken along line A-A. The insulating layer 173 is provided to be sandwiched by a portion, of the power extraction tab part 171, that corresponds to the overlap part 174 and a portion, of the power extraction tab part 172, that corresponds to the overlap part 174, for example, as illustrated in FIG. 32.

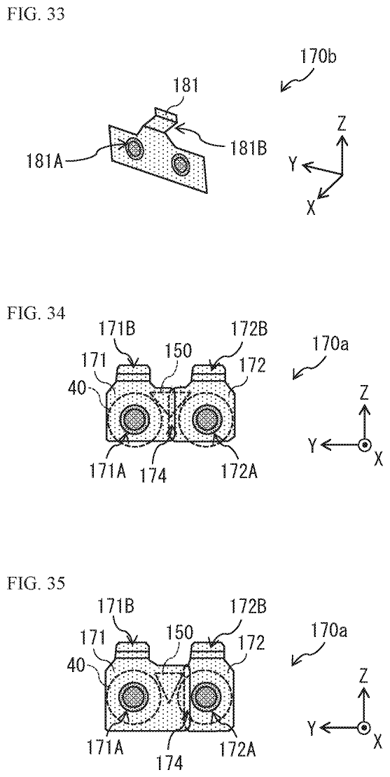

FIG. 33 illustrates an exploded perspective configuration example of the tab 170b. The tab 170b is a tab coupled to a terminal on another end side of each of the two batteries 40. The tab 170b includes an intermediate coupling tab part 181, for example, as illustrated in FIG. 33. The intermediate coupling tab part 181 includes a metal member. The tab 170b (specifically, the intermediate coupling tab part 181) is provided to cover, when the battery unit 120 is viewed in the axial direction of the batteries 40, one end of the heat-absorbing member 50 and one end of each of the batteries 40.

The intermediate coupling tab part 181 is coupled to the negative electrode terminal 42 of one of the two batteries 40 and to the positive electrode terminal 41 of another one of the two batteries 40. The intermediate coupling tab part 181 includes two projecting parts 181A protruding toward the batteries 40. The two projecting parts 181A are provided at a position opposed to the negative electrode terminal 42 of the one of the two batteries 40, and at a position opposed to the positive electrode terminal 41 of the other one of the two batteries 40. Out of the two projecting parts 181A, the projecting part 181A provided at the position opposed to the negative electrode terminal 42 is electrically coupled to the corresponding negative electrode terminal 42 via an electrically conductive material such as solder. Out of the two projecting parts 181A, the projecting part 181A provided at the position opposed to the positive electrode terminal 41 is electrically coupled to the corresponding positive electrode terminal 41 via an electrically conductive material such as solder.

In the tab 170a, the power extraction tab part 171 includes a hook 171B, and the power extraction tab part 172 includes a hook 172B, for example, as illustrated in part (A) of FIG. 31. In the tab 170b, the intermediate coupling tab part 181 includes a hook 181B, for example, as illustrated in FIG. 33. The hooks 171B and 172B are each engaged with the slit part 31 of the control board 30. The hooks 171B and 172B are thereby each configured to fix the tab 170a to the control board 30. The hook 181B is engaged with the slit part 31 of the control board 30. The hook 181B is thereby configured to fix the tab 170b to the control board 30.

Next, effects of the battery pack 2 will be described according to an embodiment.

In the present embodiment, the tab 170a is provided to cover, when the battery unit 120 is viewed in the axial direction of the batteries 40, one end of the heat-absorbing member 150. In addition, the tab 170b is provided to cover, when the battery unit 120 is viewed in the axial direction of the batteries 40, another end of the heat-absorbing member 150. Accordingly, when the housing body 52 cleaves and the heat-absorbing agent 51 leaks out, the tabs 170a and 170b each operate as a wall, which makes it possible to retain the heat-absorbing agent 51 within the battery unit 120. This makes it possible to suppress a decrease in heat absorption performance with the heat-absorbing agent 51. It is therefore possible to provide the battery pack 2 having a structure exhibiting high heat absorption performance with the heat-absorbing agent 51.

In the present embodiment, the tab 170a is provided to cover, when the battery unit 120 is viewed in the axial direction of the batteries 40, one end of the heat-absorbing member 150 and one end of each of the batteries 40. In addition, the tab 170b is provided to cover, when the battery unit 120 is viewed in the axial direction of the batteries 40, another end of the heat-absorbing member 150 and another end of each of the batteries 40. Accordingly, when the housing body 52 cleaves and the heat-absorbing agent 51 leaks out, the tabs 170a and 170b each operate as a wall, which makes it possible to retain the heat-absorbing agent 51 within the battery unit 120. This makes it possible to suppress a decrease in heat absorption performance with the heat-absorbing agent 51. It is therefore possible to provide the battery pack 2 having a structure exhibiting high heat absorption performance with the heat-absorbing agent 51.

In the present embodiment, when the battery unit 120 is viewed in the axial direction of the batteries 40, the side plate part 61 of the holder 160a covers one end of the heat-absorbing member 150, and also covers a location, of one end of each of the batteries 40, excluding at least a part of the positive electrode terminal 41 and a part of the negative electrode terminal 42. In addition, when the battery unit 120 is viewed in the axial direction of the batteries 40, the side plate part 61 of the holder 160b covers another end of the heat-absorbing member 150, and also covers a location, of another end of each of the batteries 40, excluding at least a part of the positive electrode terminal 41 and a part of the negative electrode terminal 42. Accordingly, when the housing body 52 cleaves and the heat-absorbing agent 51 leaks out, the side plate parts 61 each operate as a wall, which makes it possible to retain the heat-absorbing agent 51 within the battery unit 120. This makes it possible to suppress a decrease in heat absorption performance with the heat-absorbing agent 51. It is therefore possible to provide the battery pack 2 having a structure exhibiting high heat absorption performance with the heat-absorbing agent 51.

In the present embodiment, the tab 170a is a tab module including the overlap part 174 in which the power extraction tab part 171 and the power extraction tab part 172 overlap each other. The overlap part 174 is disposed at the position opposed to the heat-absorbing member 150 that is disposed between the battery 40 coupled to the power extraction tab part 171 and the battery 40 coupled to the power extraction tab part 172. Accordingly, when the housing body 52 cleaves and the heat-absorbing agent 51 leaks out, the tab 170a (specifically, the power extraction tab parts 171 and 172) and the tab 170b (specifically, the intermediate coupling tab part 181) each operate as a wall, which makes it possible to retain the heat-absorbing agent 51 within the battery unit 120. This makes it possible to suppress a decrease in heat absorption performance with the heat-absorbing agent 51. It is therefore possible to provide the battery pack 2 having a structure exhibiting high heat absorption performance with the heat-absorbing agent 51.

In the present embodiment, the insulating layer 173 is provided that electrically insulates the power extraction tab part 171 and the power extraction tab part 172 from each other. This makes it possible to provide the tab 170a as a single-piece part without deteriorating an electrical function of the tab 170a.

In the present embodiment, the tab 170a is provided with the hooks 171B and 172B, and the tab 170b is provided with the hook 181B. This makes it possible to prevent, when the housing body 52 cleaves and the heat-absorbing agent 51 leaks out, detachment of the tabs 170a and 170b from the battery unit 120.

Next, a description will be given of modification examples of the battery pack 2 according to an embodiment.

In the second embodiment, when the battery unit 120 is viewed in the axial direction of the batteries 40, the tab 170a (specifically, the power extraction tab parts 171 and 172) may be provided to cover one end of the heat-absorbing member 150, and to expose a part of one end of each of the batteries 40, for example, as illustrated in FIG. 34. In the second embodiment, when the battery unit 120 is viewed in the axial direction of the batteries 40, the tab 170b (specifically, the intermediate coupling tab part 181) may be provided to cover another end of the heat-absorbing member 150, and to expose a part of another end of each of the batteries 40.

In this case also, when the housing body 52 cleaves and the heat-absorbing agent 51 leaks out, the tabs 170a and 170b each operate as a wall, which makes it possible to retain the heat-absorbing agent 51 within the battery unit 120. This makes it possible to suppress a decrease in heat absorption performance with the heat-absorbing agent 51. It is therefore possible to provide the battery pack 2 having a structure exhibiting high heat absorption performance with the heat-absorbing agent 51.

In the second embodiment and Modification example 2-1, the overlap part 174 may not be disposed at a position opposed to one end of the heat-absorbing members 150, and may be disposed at a position not opposed to the one end of the heat-absorbing member 150, for example, as illustrated in FIG. 35. This makes it possible to suppress a decrease in heat absorption performance with the heat-absorbing agent 51 similarly to the second embodiment and Modification example 2-1 of the second embodiment. It is therefore possible to provide the battery pack 2 having a structure exhibiting high heat absorption performance with the heat-absorbing agent 51.

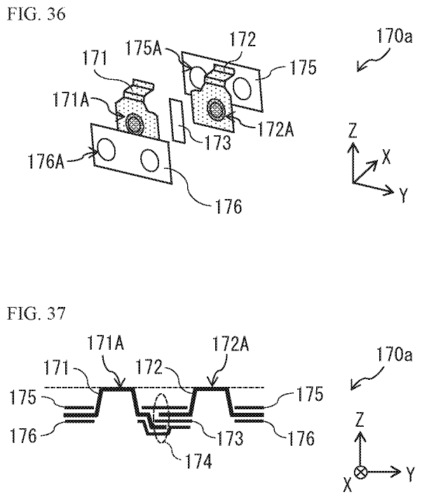

In the second embodiment and Modification examples 2-1 and 2-2, the tab 170a may further include insulating layers 175 and 176, for example, as illustrated in FIG. 36. The insulating layer 175 is interposed between the power extraction tab part 172 and the two batteries 40. The insulating layer 175 has two openings 174A at respective positions opposed to the projecting part 171A and the projecting part 172A. The power extraction tab part 171 is electrically coupled to the negative electrode terminal 42 of the battery 40 that is opposed to the power extraction tab part 171, through the opening 175A of the insulating layer 175. The power extraction tab part 172 is electrically coupled to the positive electrode terminal 41 of the battery 40 that is opposed to the power extraction tab part 172, through the opening 175A of the insulating layer 175.

The insulating layer 176 is interposed between the power extraction tab part 171 and the inner wall of the outer casing 10. The insulating layer 176 may have two openings 176A at respective positions opposed to the projecting part 171A and the projecting part 172A, for example, as illustrated in FIG. 36. The insulating layer 176 having the openings 176A improves workability when coupling the projecting parts (the projecting parts 171A and 172A) of the tab parts (the power extraction tab parts 171 and 172) to the respective batteries 40 provided at positions opposed to the projecting parts 171A and 172A. The insulating layer 176 may include, for example, a sheet having no opening. The insulating layer 176 may have, for example, the same configuration as the insulating layer 175. The insulating layers 173, 174, and 175 each include, for example, a resin sheet. The insulating layers 173, 174, and 175 are bonded to each other by, for example, thermal-fusion-bonding the resin sheets, and serve to fix a relative positional relationship between the power extraction tab parts 171 and 172.

FIG. 37 illustrates a sectional configuration example of the tab 170a of FIG. 36. The insulating layers 175 and 176 are provided to sandwich a portion, of the power extraction tab part 172, excluding the projecting part 172A (or a portion corresponding to the overlap part 174), for example, as illustrated in FIG. 37. The insulating layers 173 and 176 are provided to sandwich a portion, of the power extraction tab part 171, excluding the projecting part 171A (or a portion corresponding to the overlap part 174), for example, as illustrated in FIG. 37. In the tab 170a, respective top parts of the projecting parts 171A and respective top parts of the projecting parts 172A are disposed in the same plane. This makes it possible to provide the tab 170a as a single-piece part without deteriorating an electrical function of the tab 170a.

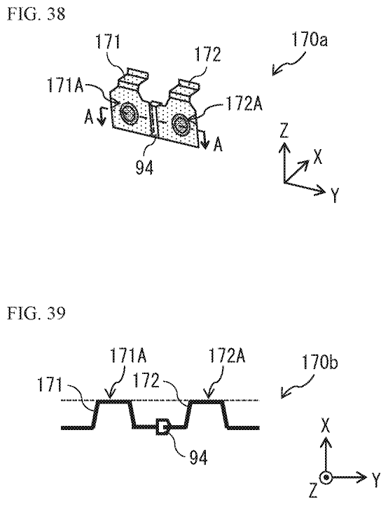

In the second embodiment and Modification examples 2-1, 2-2, and 2-3, the tab 170a may include the power extraction tab parts 171 and 172 disposed in the same plane, and in addition, may include an insulating layer 94 at a gap between an end part of the power extraction tab part 171 and an end part of the power extraction tab part 172, for example, as illustrated in FIGS. 38 and 39. The insulating layer 94 includes, for example, a resin material. The insulating layer 94 is provided to couple the end part of the power extraction tab part 171 and the end part of the power extraction tab part 172 to each other.

In this case also, when the housing body 52 cleaves and the heat-absorbing agent 51 leaks out, the tabs 170a and 170b each operate as a wall, which makes it possible to retain the heat-absorbing agent 51 within the battery unit 120. This makes it possible to suppress a decrease in heat absorption performance with the heat-absorbing agent 51. It is therefore possible to provide the battery pack 2 having a structure exhibiting high heat absorption performance with the heat-absorbing agent 51.

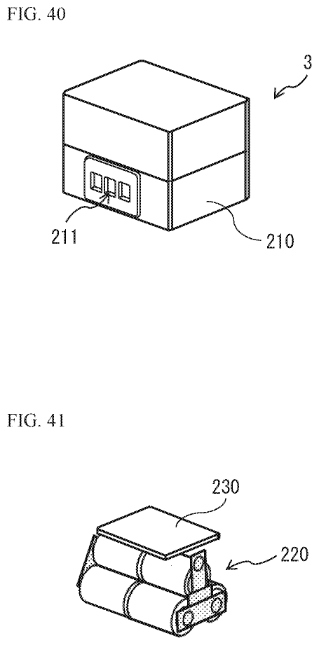

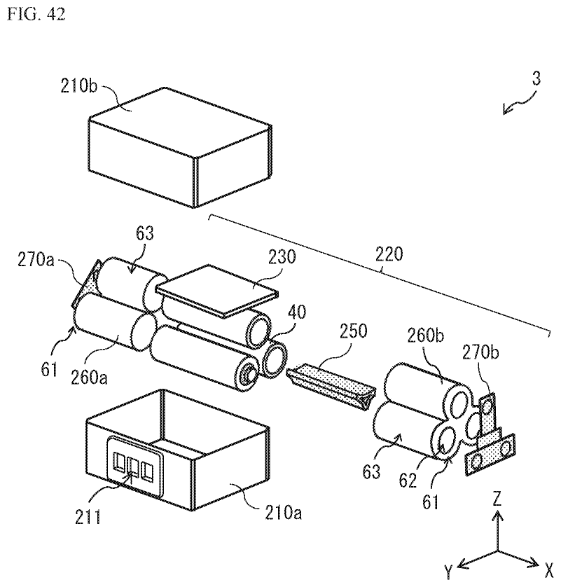

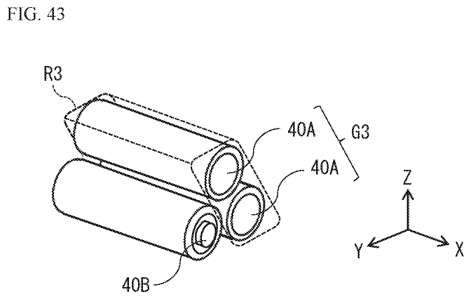

Next, a description will be given of a battery pack 3 according to a third embodiment of the present technology. FIG. 40 illustrates a perspective configuration example of the battery pack 3. FIG. 41 illustrates a perspective configuration example of components housed in the battery pack 3. FIG. 42 is a diagram illustrating an exploded perspective configuration example of the battery pack 3.

As illustrated in FIGS. 40 and 41, the battery pack 3 includes, for example, an outer casing 210, a battery unit 220 housed in the outer casing 210, and a control board 230. The control board 230 is, for example, coupled to positive and negative electrode terminals of the battery unit 220, and includes a circuit that performs operations such as measuring a voltage of batteries or the battery unit, detecting a remaining capacity of the battery unit, and detecting presence or absence of an overcurrent by measuring a current outputted from the battery unit.

The outer casing 210 includes a lower casing 210a and an upper casing 210b, for example, as illustrated in FIG. 42. The lower casing 210a and the upper casing 210b are stacked on each other to provide a housing space that houses the battery unit 220 and the control board 230. The outer casing 210 (for example, the lower casing 210a) is provided with an external terminal 211 coupled to the control board 230. The battery unit 220 is coupled to the external terminal 211 via the control board 230.

The battery unit 220 includes three batteries 40 and two tabs, a tab 270a and a tab 270b. The three batteries 40 are so disposed that respective axial directions of the batteries 40 face in the same direction (for example, the X direction in FIG. 42). The two tabs 270a and 270b are disposed to be opposed to each other with the three batteries 40 interposed therebetween. The tab 270a is disposed on one end side of each of the batteries 40, and the tab 270b is disposed on another end side of each of the batteries 40. The three batteries 40 are electrically coupled to each other via the two tabs 270a and 270b. For example, the three batteries 40 are coupled in series to each other via the two tabs 270a and 270b. A specific configuration of each of the tabs 270a and 270b will be described in detail later.

The battery unit 220 further includes one heat-absorbing member 250 and a battery holder 260. The one heat-absorbing member 250 extends in the axial direction of the batteries 40. The battery holder 260 holds the three batteries 40 in layered form. The one heat-absorbing member 250 is disposed in the battery holder 260. The one heat-absorbing member 250 is disposed in a gap having a triangular prism shape provided between the three batteries 40 adjacent to each other. The heat-absorbing member 250 has a configuration in common with the heat-absorbing member 50 except that the section thereof is substantially triangular.

The battery holder 260 includes a pair of holders 260a and 260b, for example, as illustrated in FIG. 42. The holders 260a and 260b have a common structure. The holders 260a and 260b have configurations common with the holders 60a and 60b except that the number of batteries 40 held by the holders 260a and 260b is three.

Each of the holders 260a and 260b includes, for example, the side plate part 61. The side plate part 61 of the holder 260a and the side plate part 61 of the holder 260b are disposed to be opposed to each other with the multiple batteries 40 interposed therebetween in the extending direction of each of the batteries 40 (the direction in which the positive electrode terminal 41 and the negative electrode terminal 42 to be described later are opposed to each other). In the holders 260a and 260b, the side plate parts 61 have the openings 62 at locations opposed to the positive electrode terminals 41 and the negative electrode terminals 42 of the batteries 40. Thus, the positive electrode terminal 41 or the negative electrode terminal 42 is exposed in each of the openings 62. Further, when the battery unit 220 is viewed in the axial direction of the batteries 40, the side plate part 61 covers one end of each of the one heat-absorbing member 250, and also covers a location, of one end of each of the batteries 40, excluding at least a part of the positive electrode terminal 41 and a part of the negative electrode terminal 42. Specifically, the side plate part 61 covers a portion, of the first end face 40a and the second end face 40b of each of the batteries 40, excluding the positive electrode terminal 41 and the negative electrode terminal 42. Note that as long as the positive electrode terminal 41 and the negative electrode terminal 42 are electrically couplable to the tabs 270a and 270b, a part of the positive electrode terminal 41 and a part of the negative electrode terminal 42 may be covered with the side plate part 61.

Each of the holders 260a and 260b includes, for example, the support part 63 that supports the three batteries 40 in layered form with a predetermined gap therebetween. In the present embodiment, the term “layered form” refers to a state in which one battery 40 is stacked on an assembly including two batteries 40 arranged on the predetermined plane (the XY plane). The side plate part 61 is coupled to each of two opposite end parts of the support parts 63 as a whole. The support parts 63 support three cylindrical batteries 40 in layered form with the predetermined gap therebetween. The support parts 63 have openings 64 at locations surrounded by three cylindrical batteries 40 adjacent to each other. The locations at which the support parts 63 have the openings 64 (the locations surrounded by three cylindrical batteries 40 adjacent to each other) each serve as the housing part 65 that houses the battery 40. The number of the housing parts 65 is one.

The one heat-absorbing member 250 is disposed in one gap (the housing part 65) surrounded by the three batteries 40 adjacent to each other. The one heat-absorbing members 250 is in contact with outer peripheral surfaces of the three batteries 40 through the opening 64. The opening 64 is in contact with the side plate part 61 of the holder 260a and the side plate part 61 of the holder 260b. The one heat-absorbing member 250 is in contact with the side plate part 61 of the holder 260a and the side plate part 61 of the holder 260b through the opening 64.

Next, a specific configuration of each of the tabs 270a and 270b will be described in detail.

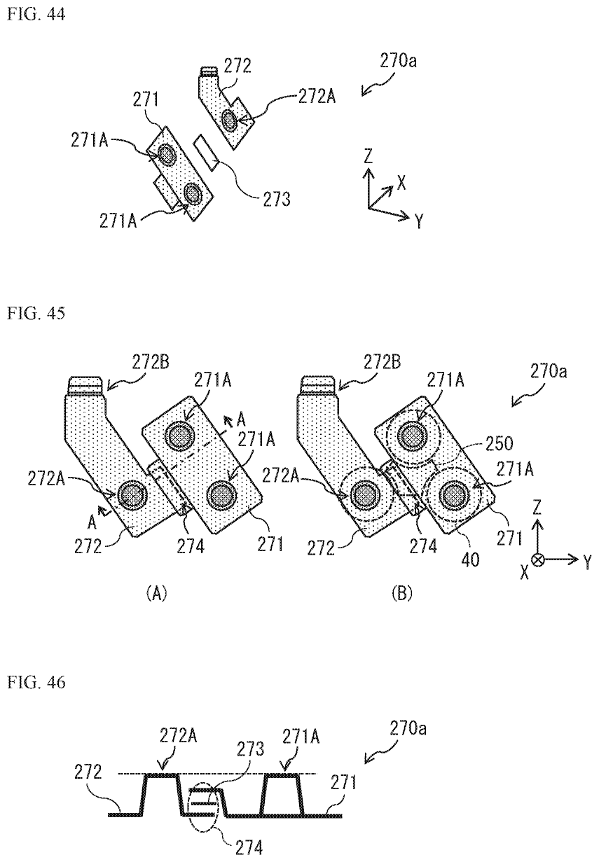

FIG. 44 illustrates an exploded perspective configuration example of the tab 270a. The tab 270a is a tab module including an intermediate coupling tab part 271 and a power extraction tab part 272, for example, as illustrated in FIG. 44. The intermediate coupling tab part 271 and the power extraction tab part 272 each include a metal member.

The power extraction tab part 272 is coupled to the positive electrode terminal 41 of one battery 40A (the third battery) out of two batteries 40A belonging to a first group G3. The power extraction tab part 172 includes a projecting part 272A protruding toward the battery 40. The projecting part 272A is provided at a position opposed to the positive electrode terminal 41 of the one battery 40A out of the two batteries 40A belonging to the first group G3. The projecting part 272A is electrically coupled to the positive electrode terminal 41 via an electrically conductive material such as solder.

The intermediate coupling tab part 271 is coupled to the positive electrode terminal 41 of another battery 40A (the fourth battery) out of the two batteries 40A belonging to the first group G3, and to the negative electrode terminal 42 of one battery 40B (the second battery) not belonging to the first group G3. The intermediate coupling tab part 271 includes two projecting parts 271A protruding toward the batteries 40. The two projecting parts 271A are provided at a position opposed to the positive electrode terminal 41 of the other battery 40A (the fourth battery) out of the two batteries 40A belonging to the first group G3, and at a position opposed to the negative electrode terminal 42 of the one battery 40B not belonging to the first group G3. Out of the two projecting parts 271A, the projecting part 271A provided at the position opposed to the positive electrode terminal 41 is electrically coupled to the corresponding positive electrode terminal 41 via an electrically conductive material such as solder. Out of the two projecting parts 271A, the projecting part 271A provided at the position opposed to the negative electrode terminal 42 is electrically coupled to the corresponding negative electrode terminal 42 via an electrically conductive material such as solder.

The tab 270a further includes an insulating layer 273, for example, as illustrated in FIG. 44. The insulating layer 273 is interposed between the intermediate coupling tab part 271 and the power extraction tab part 272. The insulating layer 273 is configured to electrically insulate the intermediate coupling tab part 271 and the power extraction tab part 272 from each other. The insulating layer 273 includes, for example, a resin sheet. The intermediate coupling tab part 271, the power extraction tab part 272, and the insulating layer 273 are bonded to each other by, for example, thermal-fusion-bonding the resin sheet included in the insulating layer 273. Thus, the insulating layer 273 serves to fix a relative positional relationship between the intermediate coupling tab part 271 and the power extraction tab part 272.

Part (A) of FIG. 45 illustrates a planar configuration example of the intermediate coupling tab part 271 and the power extraction tab part 272 included in the tab 270a. Part (B) of FIG. 45 illustrates a configuration example in which a planar configuration of the batteries 40 and the heat-absorbing member 250 is superimposed on the planar configuration of part (A) of FIG. 45. In the tab 270a, a part of the intermediate coupling tab part 271 and a part of the power extraction tab part 272 overlap each other. That is, the tab 270a includes an overlap part 274 in which the intermediate coupling tab part 271 and the power extraction tab part 272 overlap each other. The overlap part 274 is disposed at a position opposed to the heat-absorbing member 250 that is provided between the one battery 40 coupled to the power extraction tab part 272 and the two batteries 40 coupled to the intermediate coupling tab part 271, for example, as illustrated in part (B) of FIG. 45.

FIG. 46 illustrates a sectional configuration example of part (A) of FIG. 45 taken along line A-A. The insulating layer 273 is provided to be sandwiched by a portion, of the intermediate coupling tab part 271, excluding the projecting part 271A and a portion, of the power extraction tab part 272, excluding the projecting part 272A, for example, as illustrated in FIG. 46.

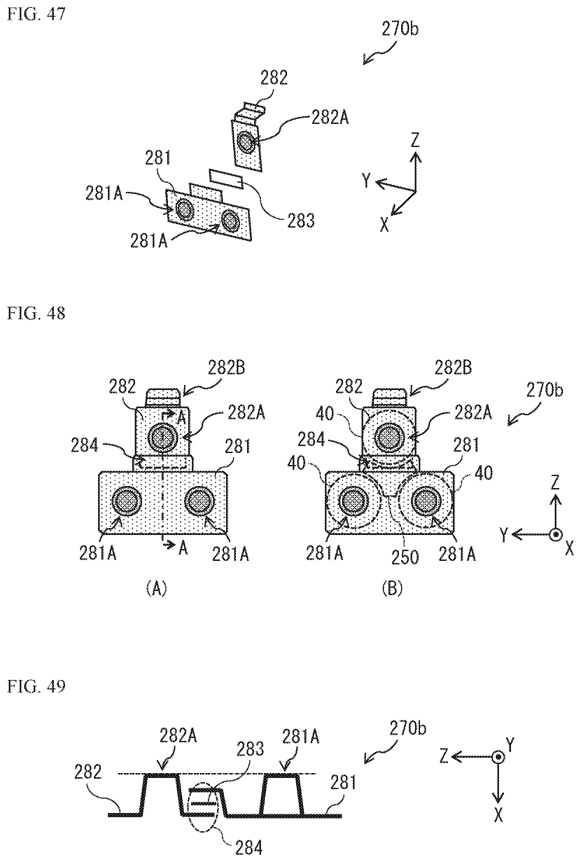

FIG. 47 illustrates an exploded perspective configuration example of the tab 270b. The tab 270b is a tab (the second tab) coupled to a terminal on another end side of each of the three batteries 40. The tab 270b is a tab module including an intermediate coupling tab part 281 and a power extraction tab part 282, for example, as illustrated in FIG. 47. The intermediate coupling tab part 281 and the power extraction tab part 282 each include a metal member.

The intermediate coupling tab part 281 is coupled to the negative electrode terminal 42 of one battery 40A (the third battery) out of the two batteries 40A belonging to the first group G3, and to the positive electrode terminal 41 of one battery 40B (the second battery) not belonging to the first group G3. The intermediate coupling tab part 281 includes two projecting parts 281A protruding toward the batteries 40. The two projecting parts 281A are provided at a position opposed to the negative electrode terminal 42 of the one battery 40A (the third battery) out of the two batteries 40A belonging to the first group G3, and at a position opposed to the positive electrode terminal 41 of the one battery 40B (the second battery) not belonging to the first group G3. Out of the two projecting parts 281A, the projecting part 281A provided at the position opposed to the negative electrode terminal 42 is electrically coupled to the corresponding negative electrode terminal 42 via an electrically conductive material such as solder. Out of the two projecting parts 281A, the projecting part 281A provided at the position opposed to the positive electrode terminal 41 is electrically coupled to the corresponding positive electrode terminal 41 via an electrically conductive material such as solder.

The power extraction tab part 282 is coupled to the negative electrode terminal 42 of the other battery 40A (the fourth battery) out of two batteries 40A belonging to the first group G3. The power extraction tab part 282 includes a projecting part 282A protruding toward the battery 40. The projecting part 282A is provided at a position opposed to the negative electrode terminal 42 of the other battery 40A (the fourth battery) out of the two batteries 40A belonging to the first group G3. The projecting part 282A is electrically coupled to the negative electrode terminal 42 via an electrically conductive material such as solder.

The tab 270b further includes an insulating layer 283, for example, as illustrated in FIG. 47. The insulating layer 283 is interposed between the intermediate coupling tab part 281 and the power extraction tab part 282. The insulating layer 283 is configured to electrically insulate the intermediate coupling tab part 281 and the power extraction tab part 282 from each other. The insulating layer 283 includes, for example, a resin sheet. The intermediate coupling tab part 281, the power extraction tab part 282, and the insulating layer 283 are bonded to each other by, for example, thermal-fusion-bonding the resin sheet included in the insulating layer 283. Thus, the insulating layer 283 serves to fix a relative positional relationship between the intermediate coupling tab part 281 and the power extraction tab part 282.

Part (A) of FIG. 48 illustrates a planar configuration example of the intermediate coupling tab part 281 and the power extraction tab part 282 included in the tab 270b. Part (B) of FIG. 48 illustrates a configuration example in which a planar configuration of the batteries 40 and the heat-absorbing member 250 is superimposed on the planar configuration of part (A) of FIG. 48. In the tab 270b, a part of the intermediate coupling tab part 281 and a part of the power extraction tab part 282 overlap each other. That is, the tab 270b includes an overlap part 284 in which the intermediate coupling tab part 281 and the power extraction tab part 282 overlap each other. The overlap part 284 is disposed at a position opposed to the heat-absorbing member 250 that is provided between the one battery 40 coupled to the power extraction tab part 282 and the two batteries 40 coupled to the intermediate coupling tab part 281, for example, as illustrated in part (B) of FIG. 48.

FIG. 49 illustrates a sectional configuration example of part (A) of FIG. 48 taken along line A-A. The insulating layer 284 is provided in a gap between a portion, of the intermediate coupling tab part 281, excluding the projecting part 281A and a portion, of the power extraction tab part 282, excluding the projecting part 282A, for example, as illustrated in FIG. 49.

In the tab 270a, the power extraction tab part 272 includes a hook 272B, for example, as illustrated in part (A) FIG. 45. The hook 272B is engaged with the slit part 31 of the control board 230. The hook 272B is thereby configured to fix the tab 270a to the control board 230.

Next, effects of the battery pack 3 will be described.

In the present embodiment, the tab 270a is provided to cover, when the battery unit 220 is viewed in the axial direction of the batteries 40, one end of the heat-absorbing member 250. In addition, the tab 270b is provided to cover, when the battery unit 220 is viewed in the axial direction of the batteries 40, another end of the heat-absorbing member 250. Accordingly, when the housing body 52 cleaves and the heat-absorbing agent 51 leaks out, the tabs 270a and 270b each operate as a wall, which makes it possible to retain the heat-absorbing agent 51 within the battery unit 220. This makes it possible to suppress a decrease in heat absorption performance with the heat-absorbing agent 51. It is therefore possible to provide the battery pack 3 having a structure exhibiting high heat absorption performance with the heat-absorbing agent 51.

In the present embodiment, the tab 270a is provided to cover, when the battery unit 220 is viewed in the axial direction of the batteries 40, one end of the heat-absorbing member 250 and one end of each of the batteries 40. In addition, the tab 270b is provided to cover, when the battery unit 220 is viewed in the axial direction of the batteries 40, another end of the heat-absorbing member 250 and another end of each of the batteries 40. Accordingly, when the housing body 52 cleaves and the heat-absorbing agent 51 leaks out, the tabs 270a and 270b each operate as a wall, which makes it possible to retain the heat-absorbing agent 51 within the battery unit 220. This makes it possible to suppress a decrease in heat absorption performance with the heat-absorbing agent 51. It is therefore possible to provide the battery pack 3 having a structure exhibiting high heat absorption performance with the heat-absorbing agent 51.

In the present embodiment, when the battery unit 220 is viewed in the axial direction of the batteries 40, the side plate part 61 of the holder 260a covers one end of the heat-absorbing member 250, and also covers a location, of one end of each of the batteries 40, excluding at least a part of the positive electrode terminal 41 and a part of the negative electrode terminal 42. In addition, when the battery unit 220 is viewed in the axial direction of the batteries 40, the side plate part 61 of the holder 260b covers another end of the heat-absorbing member 250, and also covers a location, of another end of each of the batteries 40, excluding at least a part of the positive electrode terminal 41 and a part of the negative electrode terminal 42. Accordingly, when the housing body 52 cleaves and the heat-absorbing agent 51 leaks out, the side plate parts 61 each operate as a wall, which makes it possible to retain the heat-absorbing agent 51 within the battery unit 220. This makes it possible to suppress a decrease in heat absorption performance with the heat-absorbing agent 51. It is therefore possible to provide the battery pack 3 having a structure exhibiting high heat absorption performance with the heat-absorbing agent 51.

In the present embodiment, the tab 270a is a tab module including the overlap part 274 in which the power extraction tab part 272 and the intermediate coupling tab part 271 overlap each other. In addition, the tab 270b is a tab module including the overlap part 284 in which the power extraction tab part 282 and the intermediate coupling tab part 281 overlap each other. The overlap part 274 is disposed at a position opposed to the heat-absorbing member 250 that is provided between the one battery 40 coupled to the power extraction tab part 272 and the two batteries 40 coupled to the intermediate coupling tab part 271. The overlap part 284 is disposed at a position opposed to the heat-absorbing member 250 that is provided between the one battery 40 coupled to the power extraction tab part 282 and the two batteries 40 coupled to the intermediate coupling tab part 281. Accordingly, when the housing body 52 cleaves and the heat-absorbing agent 51 leaks out, the tab 270a (specifically, the power extraction tab part 272 and the intermediate coupling tab part 271) and the tab 270b (specifically, the power extraction tab part 282 and the intermediate coupling tab part 281) each operate as a wall, which makes it possible to retain the heat-absorbing agent 51 within the battery unit 220. This makes it possible to suppress a decrease in heat absorption performance with the heat-absorbing agent 51. It is therefore possible to provide the battery pack 3 having a structure exhibiting high heat absorption performance with the heat-absorbing agent 51.

In the present embodiment, the insulating layer 273 is provided that electrically insulates the power extraction tab part 272 and the intermediate coupling tab part 271 from each other, and the insulating layer 283 is provided that electrically insulates the power extraction tab part 282 and the intermediate coupling tab part 281 from each other. This makes it possible to provide the tab 270a as a single-piece part without deteriorating an electrical function of the tab 270a, and to provide the tab 270b as a single-piece part without deteriorating an electrical function of the tab 270b.

In the present embodiment, the tab 270a is provided with the hook 272B, and the tab 270b is provided with the hook 282B. This makes it possible to prevent detachment of the tabs 270a and 270b from the battery unit 220 due to a force of gas discharge during an abnormal event, and to retain the leaked heat-absorbing agent 51.

Next, a description will be given of modification examples of the battery pack 3.

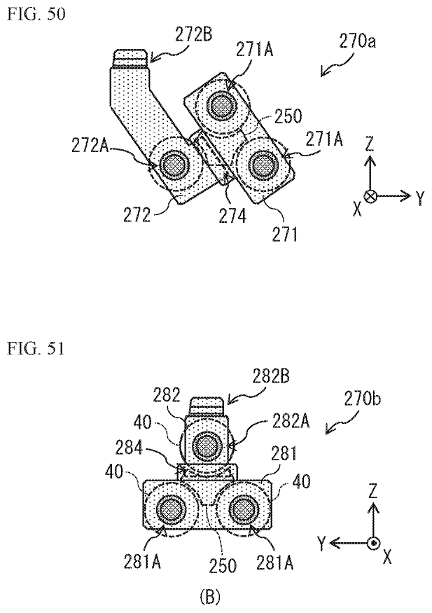

In the third embodiment, when the battery unit 220 is viewed in the axial direction of the batteries 40, the tab 270a (specifically, the power extraction tab part 272 and the intermediate coupling tab part 271) may be provided to cover one end of the heat-absorbing member 250, and to expose a part of one end of each of the batteries 40, for example, as illustrated in FIG. 50. In the third embodiment, when the battery unit 220 is viewed in the axial direction of the batteries 40, the tab 270b (specifically, the power extraction tab part 282 and the intermediate coupling tab part 281) may be provided to cover another end of the heat-absorbing member 250, and to expose a part of another end of each of the batteries 40, for example, as illustrated in FIG. 51.

In this case also, when the housing body 52 cleaves and the heat-absorbing agent 51 leaks out, the tabs 270a and 270b each operate as a wall, which makes it possible to retain the heat-absorbing agent 51 within the battery unit 220. This makes it possible to suppress a decrease in heat absorption performance with the heat-absorbing agent 51. It is therefore possible to provide the battery pack 3 having a structure exhibiting high heat absorption performance with the heat-absorbing agent 51.

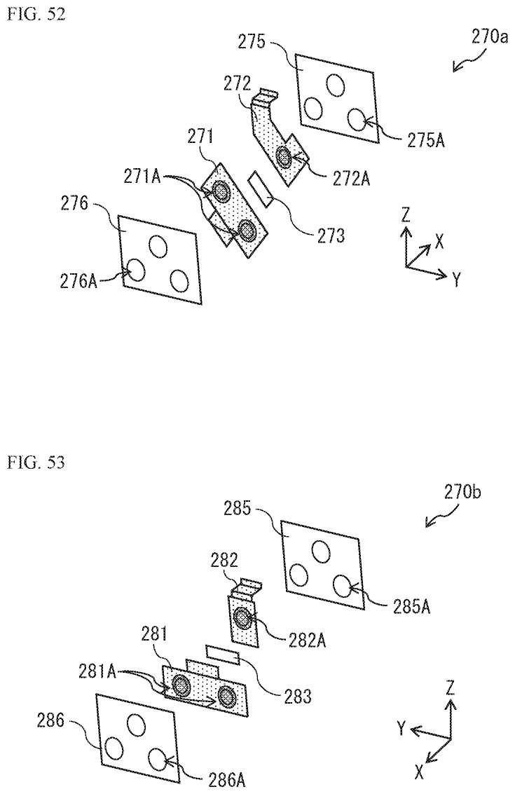

In the third embodiment and Modification example 3-1, the tab 270 a may further include insulating layers 275 and 276, for example, as illustrated in FIG. 52. The insulating layer 275 is interposed between the power extraction tab part 272 and the three batteries 40. The insulating layer 275 has three openings 275A at respective positions opposed to the two projecting parts 271A and the one projecting part 272A. The power extraction tab part 272 is electrically coupled to the positive electrode terminal 41 of the battery 40 that is opposed to the power extraction tab part 272, through the opening 275A of the insulating layer 275. The intermediate coupling tab part 271 is electrically coupled to the positive electrode terminal 41 of one of the two batteries 40 opposed to the intermediate coupling tab part 271, and to the negative electrode terminal 42 of the other one of the two batteries 40 opposed to the intermediate coupling tab part 271, through two of the openings 275A of the insulating layer 275.

The insulating layer 276 is interposed between the intermediate coupling tab part 271 and the inner wall of the outer casing 210. The insulating layer 276 may have three openings 276A at respective positions opposed to the two projecting parts 271A and the one projecting part 272A, for example, as illustrated in FIG. 52. The insulating layer 276 having the openings 276A improves workability when coupling the projecting parts (the projecting parts 271A and 272A) of the tab parts (the power extraction tab part 271 and the intermediate coupling tab part 272) to the respective batteries 40 provided at positions opposed to the projecting parts 271A and 272A. The insulating layer 276 may include, for example, a sheet having no opening. The insulating layer 276 may have, for example, the same configuration as the insulating layer 275. The insulating layers 275 and 276 each include, for example, a resin sheet. The insulating layers 273, 275, and 276 are bonded to each other by, for example, thermal-fusion-bonding the resin sheets, and serve to fix a relative positional relationship between the power extraction tab part 272 and the intermediate coupling tab part 271. This makes it possible to provide the tab 270a as a single-piece part without deteriorating an electrical function of the tab 270a.

In the present modification example, the tab 270b may further include insulating layers 285 and 286, for example, as illustrated in FIG. 53. The insulating layer 285 is interposed between the power extraction tab part 282 and the three batteries 40. The insulating layer 285 has three openings 285A at respective positions opposed to the two projecting parts 281A and the one projecting part 282A. The power extraction tab part 282 is electrically coupled to the negative electrode terminal 42 of the battery 40 that is opposed to the power extraction tab part 282, through the opening 285A of the insulating layer 285. The intermediate coupling tab part 281 is electrically coupled to the negative electrode terminal 42 of one of the two batteries 40 opposed to the intermediate coupling tab part 281, and to the positive electrode terminal 41 of the other one of the two batteries 40 opposed to the intermediate coupling tab part 281, through two of the openings 285A of the insulating layer 285.

The insulating layer 286 is interposed between the intermediate coupling tab part 281 and the inner wall of the outer casing 210. The insulating layer 286 may have three openings 286A at respective positions opposed to the two projecting parts 281A and the one projecting part 282A, for example, as illustrated in FIG. 53. The insulating layer 286 having the openings 286A improves workability when coupling the projecting parts (the projecting parts 281A and 282A) of the tab parts (the intermediate coupling tab part 281 and the power extraction tab part 282) to the respective batteries 40 provided at positions opposed to the projecting parts 281A and 282A. The insulating layer 286 may include, for example, a sheet having no opening. The insulating layer 286 may have, for example, the same configuration as the insulating layer 285. The insulating layers 285 and 286 each include, for example, a resin sheet. The insulating layers 283, 285, and 286 are bonded to each other by, for example, thermal-fusion-bonding the resin sheets, and serve to fix a relative positional relationship between the power extraction tab part 282 and the intermediate coupling tab part 281. This makes it possible to provide the tab 270b as a single-piece part without deteriorating an electrical function of the tab 270b.

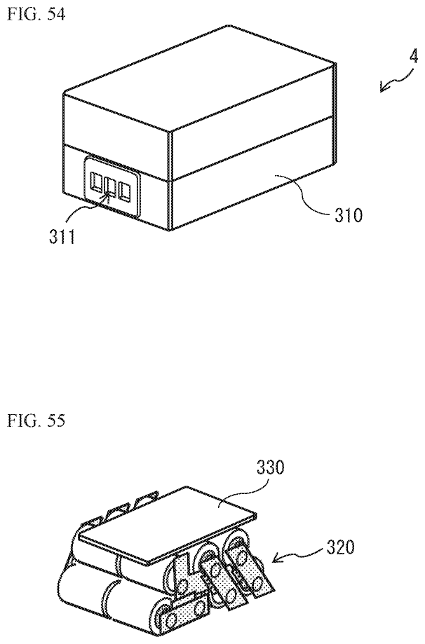

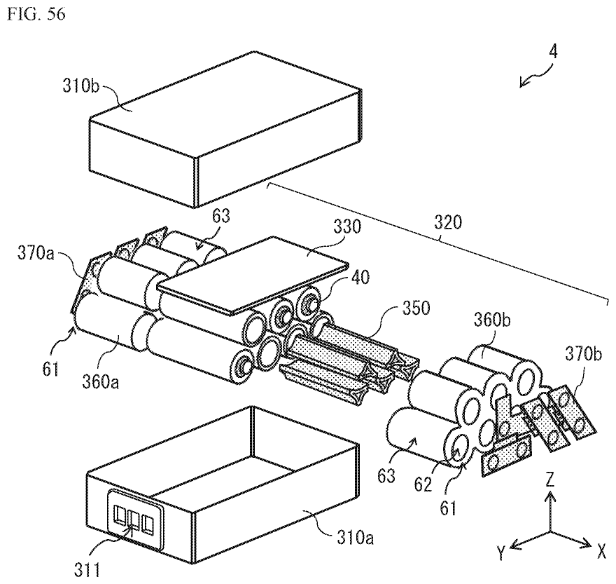

Next, a description will be given of a battery pack 4 according to a fourth embodiment of the present technology. FIG. 54 illustrates a perspective configuration example of the battery pack 4. FIG. 55 illustrates a perspective configuration example of components housed in the battery pack 4. FIG. 56 is a diagram illustrating an exploded perspective configuration example of the battery pack 4.

As illustrated in FIGS. 54 and 55, the battery pack 4 includes, for example, an outer casing 310, a battery unit 320 housed in the outer casing 310, and a control board 330. The control board 330 is, for example, coupled to positive and negative electrode terminals of the battery unit 320, and includes a circuit that performs operations such as measuring a voltage of batteries or the battery unit, detecting a remaining capacity of the battery unit, and detecting presence or absence of an overcurrent by measuring a current outputted from the battery unit.

The outer casing 310 includes a lower casing 310a and an upper casing 310b, for example, as illustrated in FIG. 56. The lower casing 310a and the upper casing 310b are stacked on each other to provide a housing space that houses the battery unit 320 and the control board 330. The outer casing 310 (for example, the lower casing 310a) is provided with an external terminal 311 coupled to the control board 330. The battery unit 320 is coupled to the external terminal 311 via the control board 330.

The battery unit 320 includes multiple batteries 40 and two tabs, a tab 370a and a tab 370b. The multiple batteries 40 are so disposed that respective axial directions of the batteries 40 face in the same direction (for example, the X direction in FIG. 56). The two tabs 370a and 370b are disposed to be opposed to each other with the multiple batteries 40 interposed therebetween. The tab 370a is disposed on one end side of each of the batteries 40, and the tab 370b is disposed on another end side of each of the batteries 40. The multiple batteries 40 are electrically coupled to each other via the two tabs 370a and 370b. For example, the multiple batteries 40 are coupled in series to each other via the two tabs 370a and 370b. Note that how the multiple batteries 40 are coupled to each other is not limited to the above. A specific configuration of each of the tabs 370a and 370b will be described in detail later. The number of the batteries 40 included in the battery unit 320 is 2×n+1 (n is an integer of two or more).

The battery unit 320 further includes multiple heat-absorbing members 350 and a battery holder 360. The multiple heat-absorbing members 350 each extend in the axial direction of the batteries 40. The battery holder 360 holds the (2×n+1)-number of batteries 40 in layered form. The multiple heat-absorbing members 350 are disposed in the battery holder 360. The number of the heat-absorbing members 350 is 2×n−1. The (2×n−1)-number of heat-absorbing members 350 are each disposed in corresponding one of (2×n−1)-number of gaps each having a triangular prism shape surrounded by the three batteries, out of the (2×n+1)-number of batteries 40, that are adjacent to each other. The heat-absorbing member 350 has a configuration in common with the heat-absorbing member 50 except that the section thereof is substantially triangular.

The battery holder 360 includes a pair of holders 360a and 360b, for example, as illustrated in FIG. 56. The holders 360a and 360b have a common structure. The holders 360a and 360b have configurations common with the holders 60a and 60b except that the number of batteries 40 held by the holders 360 a and 360 b is 2×n+1.

Each of the holders 360a and 360b includes, for example, the side plate part 61. The side plate part 61 of the holder 360a and the side plate part 61 of the holder 360b are disposed to be opposed to each other with the multiple batteries 40 interposed therebetween in the extending direction of each of the batteries 40 (the direction in which the positive electrode terminal 41 and the negative electrode terminal 42 to be described later are opposed to each other). In the holders 360a and 360b, the side plate parts 61 have the openings 62 at locations opposed to the positive electrode terminals 41 and the negative electrode terminals 42 of the batteries 40. Thus, the positive electrode terminal 41 or the negative electrode terminal 42 is exposed in each of the openings 62. Further, when the battery unit 320 is viewed in the axial direction of the batteries 40, the side plate part 61 covers one end of each of the n-number of heat-absorbing members 350, and also covers a location, of one end of each of the batteries 40, excluding at least a part of the positive electrode terminal 41 and a part of the negative electrode terminal 42. Specifically, the side plate part 61 covers a portion, of the first end face 40a and the second end face 40b of each of the batteries 40, excluding the positive electrode terminal 41 and the negative electrode terminal 42. Note that as long as the positive electrode terminal 41 and the negative electrode terminal 42 are electrically couplable to the tabs 370a and 370b, a part of the positive electrode terminal 41 and a part of the negative electrode terminal 42 may be covered with the side plate part 61.

Each of the holders 360a and 360b includes, for example, the support part 63 that supports the (2×n+1)-number of batteries 40 in layered form with predetermined gaps therebetween. In the present embodiment, the term “layered form” refers to a state in which an assembly including n-number of batteries 40 arranged on the predetermined plane (the XY plane) is stacked on an assembly including (n+1)-number of batteries 40 arranged on the predetermined plane (the XY plane). The side plate part 61 is coupled to each of two opposite end parts of the support parts 63 as a whole. The support parts 63 support (2×n+1)-number of cylindrical batteries 40 in layered form with the predetermined gaps therebetween. The support parts 63 have openings 64 at locations surrounded by three cylindrical batteries 40 adjacent to each other. The locations at which the support parts 63 have the openings 64 (the locations surrounded by three cylindrical batteries 40 adjacent to each other) each serve as the housing part 65 that houses the battery 40. The number of the housing parts 65 is n.

The (2×n−1)-number of heat-absorbing members 350 are each disposed in corresponding one of (2×n−1)-number of gaps (the housing parts 65) each surrounded by three batteries 40, out of the (2×n+1)-number of batteries 40, that are adjacent to each other. Each of the heat-absorbing members 350 is in contact with outer peripheral surfaces of the three batteries 40 through the opening 64. Each opening 64 is in contact with the side plate part 61 of the holder 360a and the side plate part 61 of the holder 360b. Each heat-absorbing members 350 is in contact with the side plate part 61 of the holder 360a and the side plate part 61 of the holder 360b through the opening 64.

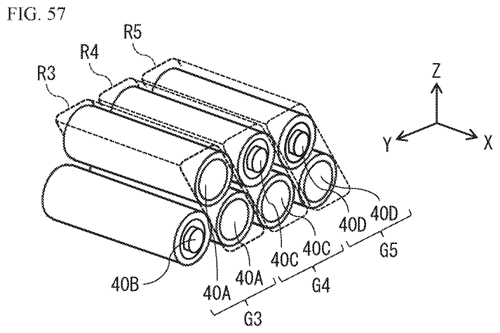

FIG. 57 illustrates an example of an arrangement of (2×n+1)-number of batteries 40 held by the battery holder 360 when n=3. Out of the (2×n+1)-number of batteries 40 held by the battery holder 360, (2×n)-number of batteries 40 each belong to any one of n-number of groups (the first group G3, a second group G4, or a third group G5). The first group G3, the second group G4, and the third group G5 are concepts that classify the (2×n)-number of batteries 40 in accordance with locations of the batteries 40. The (2×n+1)-number of batteries 40 include two batteries 40 (the first batteries) belonging to each of the groups from the first group G3 to the third group G5, and one battery 40B (the second battery) not belonging to any of the groups from the first group G3 to the third group G5.

Each of the two batteries 40A belonging to the first group G3 is so held by the battery holder 360 that the positive electrode terminal 41 is on a side of the tab 370a in the axial direction of the batteries 40. In each of the groups from the second group G4 to the third group G5, one of the batteries 40 is so held by the battery holder 360 that the positive electrode terminal 41 is on the side of the tab 370a in the axial direction of the batteries 40, and another one of the batteries 40 is so held by the battery holder 360 that the positive electrode terminal 41 is on a side of the tab 370b in the axial direction of the batteries 40. In each of the layers of the multiple batteries 40 disposed in layered form within the holder 360, the multiple batteries 40 in each of the groups are alternately disposed one by one in the first direction (the Y direction in FIG. 57) orthogonal to the axial direction of the batteries 40 (the X direction in FIG. 57).

In the second group G4, one of batteries 40C is so held by the battery holder 360 that the positive electrode terminal 41 is on the side of the tab 370a in the axial direction of the batteries 40, and another one of the batteries 40C is so held by the battery holder 360 that the positive electrode terminal 41 is on the side of the tab 370b in the axial direction of the batteries 40. In the third group G5, one of batteries 40D is so held by the battery holder 360 that the positive electrode terminal 41 is on the side of the tab 370a in the axial direction of the batteries 40, and another one of the batteries 40D is so held by the battery holder 360 that the positive electrode terminal 41 is on the side of the tab 370b in the axial direction of the batteries 40. The one battery 40B not belonging to any of the groups from the first group G3 to the third group G5 is so held by the battery holder 360 that the positive electrode terminal 41 is on the side of the tab 370b in the axial direction of the batteries 40.

Each of the batteries 40A belonging to the first group G3 is disposed in a region R3. The region R3 extends over layers of multiple batteries 40 disposed in layered form within the battery holder 360. Each of the batteries 40C belonging to the second group G4 is disposed in a region R4. The region R4 extends over layers of multiple batteries 40 disposed in layered form within the battery holder 360. Each of the batteries 40D belonging to the third group G5 is disposed in a region R5. The region R5 extends over layers of multiple batteries 40 disposed in layered form within the battery holder 360. The regions R3, R4, and R5 each extend in a direction that intersects a normal to the predetermined plane (XY plane) at an oblique angle (for example, at an angle of 45 degrees). In each of the layers of the multiple batteries 40 disposed in layered form within the battery holder 360, the batteries 40A, 40C, and 40D are alternately disposed one by one in the first direction (the Y direction in FIG. 57) orthogonal to the axial direction of the batteries 40 (the X direction in FIG. 57).

Next, a specific configuration of each of the tabs 370a and 370b will be described in detail.

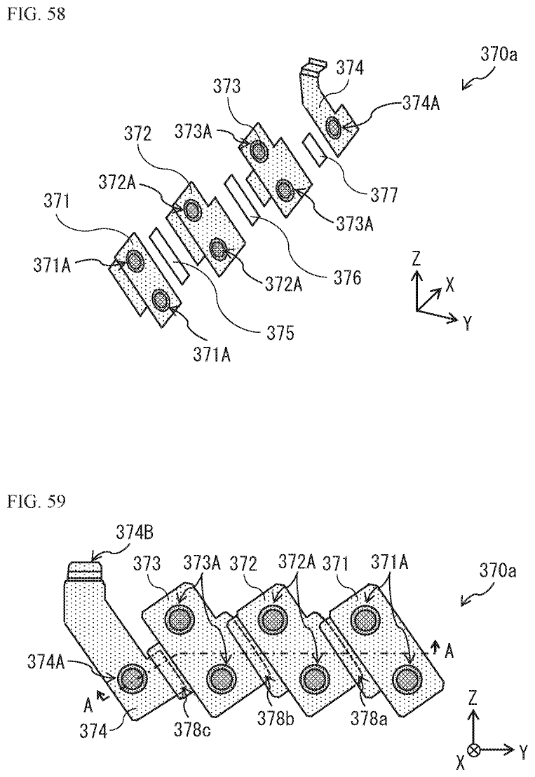

FIG. 58 illustrates an exploded perspective configuration example of the tab 370a when n=3. The tab 370a is a tab module including n-number of intermediate coupling tab parts (intermediate coupling tab parts 371, 372, and 373) and one power extraction tab part 374. The n-number of intermediate coupling tab parts (the intermediate coupling tab parts 371, 372, and 373) and the one power extraction tab part 374 each include a metal member.

The (n−1)-number of intermediate coupling tab parts (the intermediate coupling tab parts 372 and 373) are each coupled to the negative electrode terminal 42 of one of the batteries 40 belonging to the k-th group (where k is any integer from 2 to n), and to the positive electrode terminal 41 of one of the batteries 40 belonging to the (k−1)th group. The remaining one intermediate coupling tab part (the intermediate coupling tab part 371) is coupled to the positive electrode terminal 41 of one battery 40A out of the two batteries 40A belonging to the first group G3, and to the negative electrode terminal 42 of the battery 40B not belonging to any of the first to n-th groups.

The intermediate coupling tab part 372 is coupled to the negative electrode terminal 42 of the battery 40C belonging to the second group G4, and to the positive electrode terminal 41 of the battery 40A belonging to the first group. The intermediate coupling tab part 373 is coupled to the negative electrode terminal 42 of the battery 40D belonging to the third group G5, and to the positive electrode terminal 41 of the battery 40A belonging to the second group. The intermediate coupling tab part 371 is coupled to the positive electrode terminal 41 of the battery 40A not coupled to the intermediate coupling tab part 372, out of the two batteries 40A belonging to the first group G3, and to the negative electrode terminal 42 of the battery 40B not belonging to any of the first to third groups G3 to G5.

The tab 370a further includes insulating layers 375, 376, and 377, for example, as illustrated in FIG. 58. The insulating layer 375 is interposed between the intermediate coupling tab part 371 and the intermediate coupling tab part 372. The insulating layer 375 is configured to electrically insulate the intermediate coupling tab part 371 and the intermediate coupling tab part 372 from each other. The insulating layer 376 is interposed between the intermediate coupling tab part 372 and the intermediate coupling tab part 373. The insulating layer 376 is configured to electrically insulate the intermediate coupling tab part 372 and the intermediate coupling tab part 373 from each other. The insulating layer 377 is interposed between the intermediate coupling tab part 373 and the power extraction tab part 374. The insulating layer 377 is configured to electrically insulate the intermediate coupling tab part 373 and the power extraction tab part 374 from each other.

The insulating layers 375, 376, and 377 each include, for example, a resin sheet. The intermediate coupling tab parts 371, 372, and 373, the power extraction tab part 374, and the insulating layers 375, 376, and 377 are bonded to each other by, for example, thermal-fusion-bonding the resin sheets included in the insulating layer 375, 376, and 377. Thus, the insulating layer 375, 376, and 377 serve to fix a relative positional relationship between the intermediate coupling tab part 371, 372, and 373 and the power extraction tab part 374.

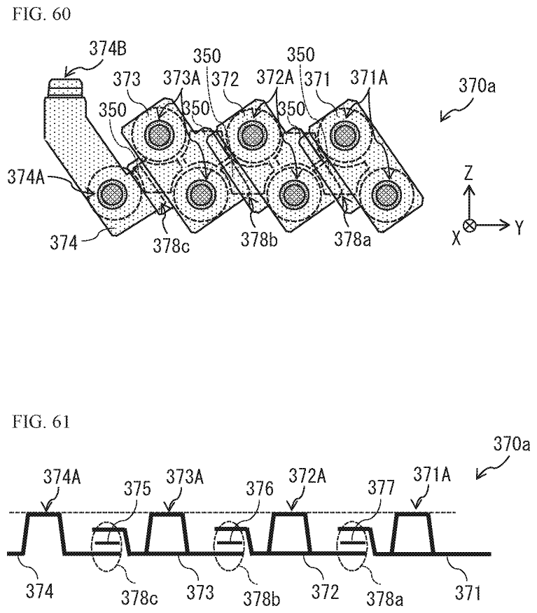

FIG. 59 illustrates a planar configuration example of the intermediate coupling tab parts 371, 372, and 373 and the power extraction tab part 374 included in the tab 370a. FIG. 60 illustrates a configuration example in which a planar configuration of the batteries 40 and the heat-absorbing members 350 is superimposed on the planar configuration of FIG. 59. In the tab 370a, a part of the intermediate coupling tab part 371 and a part of the intermediate coupling tab part 372 overlap each other. That is, the tab 370a includes an overlap part 378a in which the intermediate coupling tab part 371 and the intermediate coupling tab part 372 overlap each other. The overlap part 378a is disposed at a position opposed to the heat-absorbing member 350 that is provided between the two batteries 40 coupled to the intermediate coupling tab part 371 and one battery 40 coupled to the intermediate coupling tab part 372, for example, as illustrated in FIG. 60.

In the tab 370a, a part of the intermediate coupling tab part 372 and a part of the intermediate coupling tab part 373 overlap each other. That is, the tab 370a includes an overlap part 378b in which the intermediate coupling tab part 372 and the intermediate coupling tab part 373 overlap each other. The overlap part 378b is disposed at a position opposed to the heat-absorbing member 350 that is provided between the two batteries 40 coupled to the intermediate coupling tab part 372 and one battery 40 coupled to the intermediate coupling tab part 373, for example, as illustrated in FIG. 60.

In the tab 370a, a part of the intermediate coupling tab part 373 and a part of the power extraction tab part 374 overlap each other. That is, the tab 370a includes an overlap part 378c in which the intermediate coupling tab part 373 and the power extraction tab part 374 overlap each other. The overlap part 378c is disposed at a position opposed to the heat-absorbing member 350 that is provided between the two batteries 40 coupled to the intermediate coupling tab part 373 and the one battery 40 coupled to the power extraction tab part 374, for example, as illustrated in FIG. 60.

FIG. 61 illustrates a sectional configuration example of FIG. 59 taken along line A-A. The insulating layer 375 is provided to be sandwiched by a portion, of the intermediate coupling tab part 373, excluding a projecting part 373A and a portion, of the power extraction tab part 374, excluding a projecting part 374A, for example, as illustrated in FIG. 61. The insulating layer 376 is provided to be sandwiched by a portion, of the intermediate coupling tab part 372, excluding a projecting part 372A and a portion, of the intermediate coupling tab part 373, excluding the projecting part 373A, for example, as illustrated in FIG. 61. The insulating layer 377 is provided to be sandwiched by a portion, of the intermediate coupling tab part 371, excluding a projecting part 371A and a portion, of the intermediate coupling tab part 372, excluding the projecting part 372A, for example, as illustrated in FIG. 61.

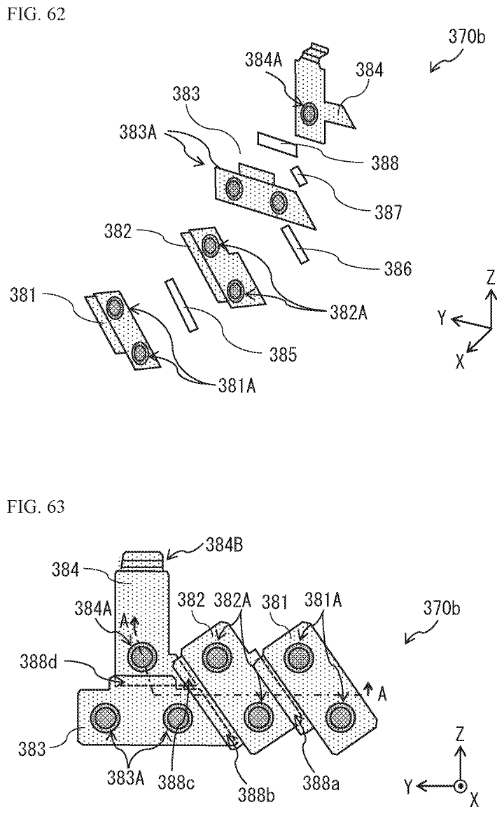

FIG. 62 illustrates an exploded perspective configuration example of the tab 370b when n=3. The tab 370b is a tab module including n-number of intermediate coupling tab parts (intermediate coupling tab parts 381, 382, and 383) and one power extraction tab part 384. The n-number of intermediate coupling tab parts (the intermediate coupling tab parts 381, 382, and 383) and the one power extraction tab part 384 each include a metal member.

The power extraction tab part 384 is coupled to the negative electrode terminal 42 of one of the batteries 40A belonging to the first group G3. The (n−1)-number of intermediate coupling tab parts (the intermediate coupling tab part 381 and 382) are each coupled to the negative electrode terminal 42 of one of the batteries 40 belonging to the k-th group (where k is any integer from 2 to n), and to the positive electrode terminal 41 of the other battery 40 belonging to the k-th group. The remaining one intermediate coupling tab part (the intermediate coupling tab part 383) is coupled to the positive electrode terminal 41 of the other battery 40A (the battery 40A not coupled to the power extraction tab part 384) out of the two batteries 40A belonging to the first group G3, and to the negative electrode terminal 42 of the battery 40B not belonging to any of the first to n-th groups.

The intermediate coupling tab part 381 is coupled to the negative electrode terminal 42 of one battery 40D out of two batteries 40D belonging to the third group G5, and to the positive electrode terminal 41 of the other battery 40D. The intermediate coupling tab part 382 is coupled to the negative electrode terminal 42 of one battery 40C out of two batteries 40C belonging to the second group G4, and to the positive electrode terminal 41 of the other battery 40C. The intermediate coupling tab part 383 is coupled to the negative electrode terminal 42 of the other battery 40C (the battery 40C not coupled to the power extraction tab part 384) out of the two batteries 40C belonging to the first group G3, and to the positive electrode terminal 41 of the battery 40B not belonging to any of the first to n-th groups.

The tab 370b further includes insulating layers 385, 386, 387, and 388, for example, as illustrated in FIG. 62. The insulating layer 385 is interposed between the intermediate coupling tab part 381 and the intermediate coupling tab part 382. The insulating layer 385 is configured to electrically insulate the intermediate coupling tab part 381 and the intermediate coupling tab part 382 from each other. The insulating layer 386 is interposed between the intermediate coupling tab part 382 and the intermediate coupling tab part 383. The insulating layer 386 is configured to electrically insulate the intermediate coupling tab part 382 and the intermediate coupling tab part 383 from each other. The insulating layer 387 is interposed between the intermediate coupling tab part 382 and the power extraction tab part 384. The insulating layer 387 is configured to electrically insulate the intermediate coupling tab part 382 and the power extraction tab part 384 from each other. The insulating layer 388 is interposed between the intermediate coupling tab part 383 and the power extraction tab part 384. The insulating layer 388 is configured to electrically insulate the intermediate coupling tab part 383 and the power extraction tab part 384 from each other.

The insulating layers 385, 386, 387, and 388 each include, for example, a resin sheet. The intermediate coupling tab parts 381, 382, and 383, the power extraction tab part 384, and the insulating layers 385, 386, 387, and 388 are bonded to each other by, for example, thermal-fusion-bonding the resin sheets included in the insulating layers 385, 386, 387, and 388. Thus, the insulating layers 385, 386, 387, and 388 serve to fix a relative positional relationship between the intermediate coupling tab parts 381, 382, and 383 and the power extraction tab part 384.

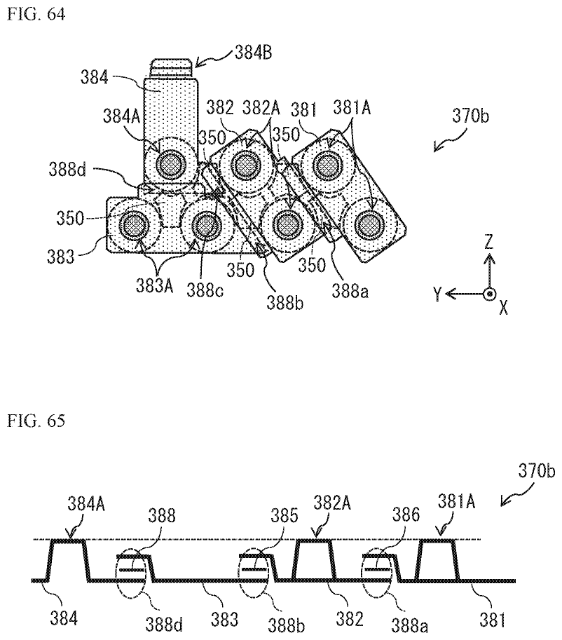

FIG. 63 illustrates a planar configuration example of the intermediate coupling tab parts 381, 382, and 383 and the power extraction tab part 384 included in the tab 370b. FIG. 64 illustrates a configuration example in which a planar configuration of the batteries 40 and the heat-absorbing members 350 is superimposed on the planar configuration of FIG. 63. In the tab 370b, a part of the intermediate coupling tab part 381 and a part of the intermediate coupling tab part 382 overlap each other. That is, the tab 370b includes an overlap part 388a in which the intermediate coupling tab part 381 and the intermediate coupling tab part 382 overlap each other. The overlap part 388a is disposed at a position opposed to the heat-absorbing member 350 that is provided between the two batteries 40 coupled to the intermediate coupling tab part 381 and one battery 40 coupled to the intermediate coupling tab part 382, for example, as illustrated in FIG. 64.

In the tab 370b, a part of the intermediate coupling tab part 382 and a part of the intermediate coupling tab part 383 overlap each other. That is, the tab 370b includes an overlap part 388b in which the intermediate coupling tab part 382 and the intermediate coupling tab part 383 overlap each other. The overlap part 388b is disposed at a position opposed to the heat-absorbing member 350 that is provided between the two batteries 40 coupled to the intermediate coupling tab part 382 and one battery 40 coupled to the intermediate coupling tab part 383, for example, as illustrated in FIG. 64.

In the tab 370b, a part of the intermediate coupling tab part 382 and a part of the power extraction tab part 384 overlap each other. That is, the tab 370b includes an overlap part 388c in which the intermediate coupling tab part 382 and the power extraction tab part 384 overlap each other. The overlap part 388c is disposed at a position opposed to the heat-absorbing member 350 that is provided between one battery 40 coupled to the intermediate coupling tab part 382, one battery 40 coupled to the intermediate coupling tab part 383, and one battery 40 coupled to the power extraction tab part 384, for example, as illustrated in FIG. 64.

In the tab 370b, a part of the intermediate coupling tab part 383 and a part of the power extraction tab part 384 overlap each other. That is, the tab 370b includes an overlap part 388d in which the intermediate coupling tab part 383 and the power extraction tab part 384 overlap each other. The overlap part 388d is disposed at a position opposed to the heat-absorbing member 350 that is provided between the two batteries 40 coupled to the intermediate coupling tab part 383 and the one battery 40 coupled to the power extraction tab part 384, for example, as illustrated in FIG. 64.

FIG. 65 illustrates a sectional configuration example of FIG. 63 taken along line A-A. The insulating layer 385 is provided to be sandwiched by a portion, of the intermediate coupling tab part 382, excluding a projecting part 382A and a portion, of the intermediate coupling tab part 383, excluding a projecting part 383A, for example, as illustrated in FIG. 65. The insulating layer 386 is provided to be sandwiched by a portion, of the intermediate coupling tab part 381, excluding a projecting part 381A and a portion, of the intermediate coupling tab part 382, excluding the projecting part 382A, for example, as illustrated in FIG. 65. The insulating layer 388 is provided to be sandwiched by a portion, of the intermediate coupling tab part 383, excluding the projecting part 383A and a portion, of the power extraction tab part 384, excluding a projecting part 384A, for example, as illustrated in FIG. 65. The insulating layer 387 is provided to be sandwiched by a portion, of the intermediate coupling tab part 382, excluding the projecting part 382A and a portion, of the power extraction tab part 384, excluding the projecting part 384A.

Next, effects of the battery pack 4 will be described according to an embodiment.

In the present embodiment, the tab 370a is provided to cover, when the battery unit 320 is viewed in the axial direction of the batteries 40, one end of each of the heat-absorbing members 350. In addition, the tab 370b is provided to cover, when the battery unit 320 is viewed in the axial direction of the batteries 40, another end of each of the heat-absorbing members 350. Accordingly, when the housing body 52 cleaves and the heat-absorbing agent 51 leaks out, the tabs 370a and 370b each operate as a wall, which makes it possible to retain the heat-absorbing agent 51 within the battery unit 320. This makes it possible to suppress a decrease in heat absorption performance with the heat-absorbing agent 51. It is therefore possible to provide the battery pack 4 having a structure exhibiting high heat absorption performance with the heat-absorbing agent 51.

In the present embodiment, the tab 370a is provided to cover, when the battery unit 320 is viewed in the axial direction of the batteries 40, one end of each of the heat-absorbing members 350 and one end of each of the batteries 40. In addition, the tab 370b is provided to cover, when the battery unit 320 is viewed in the axial direction of the batteries 40, another end of each of the heat-absorbing members 350 and another end of each of the batteries 40. Accordingly, when the housing body 52 cleaves and the heat-absorbing agent 51 leaks out, the tabs 370a and 370b each operate as a wall, which makes it possible to retain the heat-absorbing agent 51 within the battery unit 320. This makes it possible to suppress a decrease in heat absorption performance with the heat-absorbing agent 51. It is therefore possible to provide the battery pack 4 having a structure exhibiting high heat absorption performance with the heat-absorbing agent 51.

In the present embodiment, when the battery unit 320 is viewed in the axial direction of the batteries 40, the side plate part 61 of the holder 360a covers one end of each of the heat-absorbing members 350, and also covers a location, of one end of each of the batteries 40, excluding at least a part of the positive electrode terminal 41 and a part of the negative electrode terminal 42. In addition, when the battery unit 320 is viewed in the axial direction of the batteries 40, the side plate part 61 of the holder 360b covers another end of each of the heat-absorbing members 350, and also covers a location, of another end of each of the batteries 40, excluding at least a part of the positive electrode terminal 41 and a part of the negative electrode terminal 42. Accordingly, when the housing body 52 cleaves and the heat-absorbing agent 51 leaks out, the side plate parts 61 each operate as a wall, which makes it possible to retain the heat-absorbing agent 51 within the battery unit 320. This makes it possible to suppress a decrease in heat absorption performance with the heat-absorbing agent 51. It is therefore possible to provide the battery pack 4 having a structure exhibiting high heat absorption performance with the heat-absorbing agent 51.

In the present embodiment, the tab 370a is a tab module including the overlap part 378a in which the intermediate coupling tab part 371 and the intermediate coupling tab part 372 overlap each other, the overlap part 378b in which the intermediate coupling tab part 372 and the intermediate coupling tab part 373 overlap each other, and the overlap part 378c in which the intermediate coupling tab part 373 and the power extraction tab part 374 overlap each other. In addition, the tab 370b is a tab module including the overlap part 388a in which the intermediate coupling tab part 381 and the intermediate coupling tab part 382 overlap each other, the overlap part 388b in which the intermediate coupling tab part 382 and the intermediate coupling tab part 383 overlap each other, overlap each other, the overlap part 388c in which the intermediate coupling tab part 382 and the power extraction tab part 384 overlap each other, and the overlap part 388d in which the intermediate coupling tab part 383 and the power extraction tab part 384 overlap each other.

The overlap part 378a is disposed at a position opposed to the heat-absorbing member 350 that is provided between the two batteries 40 coupled to the intermediate coupling tab part 371 and the one battery 40 coupled to the intermediate coupling tab part 372. The overlap part 378b is disposed at a position opposed to the heat-absorbing member 350 that is provided between the two batteries 40 coupled to the intermediate coupling tab part 372 and the one battery 40 coupled to the intermediate coupling tab part 373. The overlap part 378c is disposed at a position opposed to the heat-absorbing member 350 that is provided between the two batteries 40 coupled to the intermediate coupling tab part 373 and the one battery 40 coupled to the power extraction tab part 374. Accordingly, when the housing body 52 cleaves and the heat-absorbing agent 51 leaks out, the tab 370a (specifically, the intermediate coupling tab parts 371 to 373 and the power extraction tab part 374) and the tab 370b (specifically, the intermediate coupling tab parts 381 to 383 and the power extraction tab part 384) each operate as a wall, which makes it possible to retain the heat-absorbing agent 51 within the battery unit 320. This makes it possible to suppress a decrease in heat absorption performance with the heat-absorbing agent 51. It is therefore possible to provide the battery pack 4 having a structure exhibiting high heat absorption performance with the heat-absorbing agent 51.

In the present embodiment, the insulating layer 375 is provided that electrically insulates the intermediate coupling tab part 371 and the intermediate coupling tab part 372 from each other, the insulating layer 376 is provided that electrically insulates the intermediate coupling tab part 372 and the intermediate coupling tab part 373 from each other, and the insulating layer 377 is provided that electrically insulates the intermediate coupling tab part 373 and the power extraction tab part 374 from each other. In addition, in the present embodiment, the insulating layer 385 is provided that electrically insulates the intermediate coupling tab part 381 and the intermediate coupling tab part 382 from each other, the insulating layer 386 is provided that electrically insulates the intermediate coupling tab part 382 and the intermediate coupling tab part 383 from each other, the insulating layer 387 is provided that electrically insulates the intermediate coupling tab part 382 and the power extraction tab part 384 from each other, and the insulating layer 388 is provided that electrically insulates the intermediate coupling tab part 383 and the power extraction tab part 384 from each other from each other. This makes it possible to provide the tab 370a as a single-piece part without deteriorating an electrical function of the tab 370a, and to provide the tab 370b as a single-piece part without deteriorating an electrical function of the tab 370b.

In the present embodiment, the tab 370a is provided with the hook 374B, and the tab 370b is provided with the hook 384B. This makes it possible to prevent detachment of the tabs 370a and 370b from the battery unit 320 due to a force of gas discharge during an abnormal event, and to retain the leaked heat-absorbing agent 51.

Next, a description will be given of modification examples of the battery pack 4 according to an embodiment.

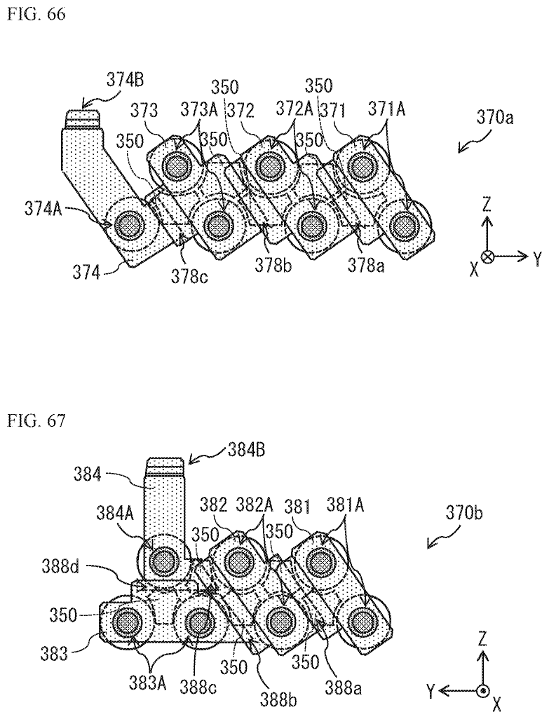

In the fourth embodiment, when the battery unit 320 is viewed in the axial direction of the batteries 40, the tab 370a may be provided to cover one end of each of the heat-absorbing members 350, and to expose a part of one end of each of the batteries 40, for example, as illustrated in FIG. 66. In the fourth embodiment, when the battery unit 320 is viewed in the axial direction of the batteries 40, the tab 370b may be provided to cover another end of each of the heat-absorbing members 350, and to expose a part of another end of each of the batteries 40, for example, as illustrated in FIG. 67.

In this case also, when the housing body 52 cleaves and the heat-absorbing agent 51 leaks out, the tabs 370a and 370b each operate as a wall, which makes it possible to retain the heat-absorbing agent 51 within the battery unit 320. This makes it possible to suppress a decrease in heat absorption performance with the heat-absorbing agent 51. It is therefore possible to provide the battery pack 4 having a structure exhibiting high heat absorption performance with the heat-absorbing agent 51.

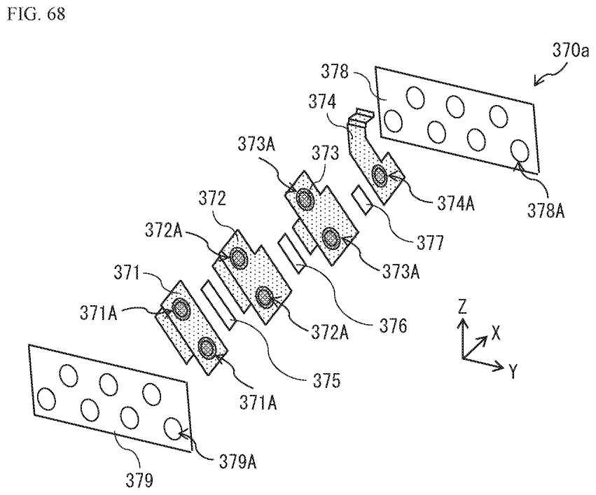

In the fourth embodiment and Modification example 4-1, the tab 370 a may further include insulating layers 378 and 379, for example, as illustrated in FIG. 68. The insulating layer 378 is interposed between the power extraction tab part 374 and the multiple batteries 40. The insulating layer 378 has multiple (seven) openings 378A at respective positions opposed to two projecting parts 371A, two projecting parts 372A, two projecting parts 373A, and one projecting part 374A. The intermediate coupling tab parts 371 to 373 and the power extraction tab part 374 are electrically coupled to the multiple (seven) batteries 40 through the multiple (seven) openings 375A of the insulating layer 378.

The insulating layer 379 is interposed between the intermediate coupling tab part 371 and the inner wall of the outer casing 310. The insulating layer 379 has multiple (seven) openings 379A at respective positions opposed to the two projecting parts 371A, the two projecting parts 372A, the two projecting parts 373A, and the one projecting part 374A, for example, as illustrated in FIG. 68. The insulating layer 379 having the openings 379A improves workability when coupling the projecting parts (the projecting parts 371A, 372A, 373A, and 374A) of the tab parts (the power extraction tab part 374 and the intermediate coupling tab parts 371, 372, and 373) to the respective batteries 40 provided at positions opposed to the projecting parts 371A, 372A, 373A, and 374A. The insulating layer 379 may include, for example, a sheet having no opening. The insulating layer 379 may have, for example, the same configuration as the insulating layer 378. The insulating layers 378 and 379 each include, for example, a resin sheet. The insulating layers 375 to 379 are bonded to each other by, for example, thermal-fusion-bonding the resin sheets, and serve to fix a relative positional relationship between the intermediate coupling tab parts 371 to 373 and the power extraction tab part 374.

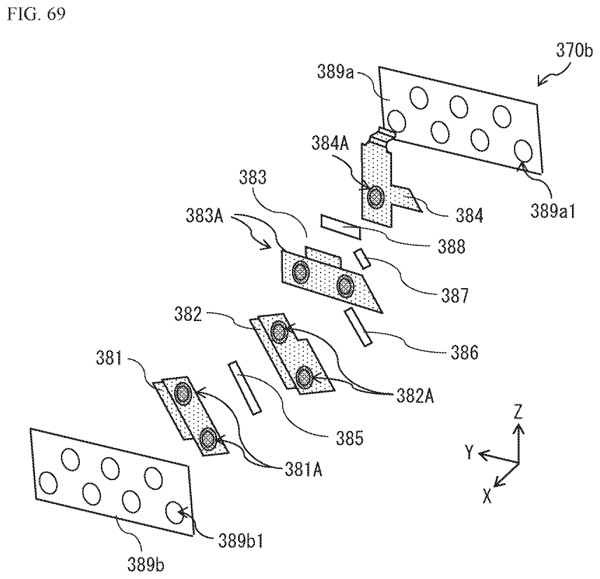

In the present modification example, the tab 370b may further include insulating layers 389a and 389b, for example, as illustrated in FIG. 69. The insulating layer 389a is interposed between the power extraction tab part 384 and the multiple batteries 40. The insulating layer 389a has multiple (seven) openings 389a1 at respective positions opposed to two projecting parts 381A, two projecting parts 382A, two projecting parts 383A, and one projecting part 384A. The intermediate coupling tab parts 381 to 383 and the power extraction tab part 384 are electrically coupled to the multiple (seven) batteries 40 through the multiple (seven) openings 389a1 of the insulating layer 389a.

The insulating layer 389b is interposed between the intermediate coupling tab part 381 and the inner wall of the outer casing 310. The insulating layer 389b has multiple (seven) openings 389b1 at respective positions opposed to the two projecting parts 381A, the two projecting parts 382A, the two projecting parts 383A, and the one projecting part 384A, for example, as illustrated in FIG. 69. The insulating layer 389b having the openings 389b1 improves workability when coupling the projecting parts (the projecting parts 381A, 382A, 383A, and 384A) of the tab parts (the power extraction tab part 384 and the intermediate coupling tab parts 381, 382, and 383) to the respective batteries 40 provided at positions opposed to the projecting parts 381A, 382A, 383A, and 384A. The insulating layer 389b may include, for example, a sheet having no opening. The insulating layer 389b may have, for example, the same configuration as the insulating layer 389a. The insulating layers 389a and 389b each include, for example, a resin sheet. The insulating layers 385 to 388, 389a, and 389b are bonded to each other by, for example, thermal-fusion-bonding the resin sheets, and serve to fix a relative positional relationship between the intermediate coupling tab parts 381 to 383 and the power extraction tab part 384. This makes it possible to provide the tab 370a as a single-piece part without deteriorating an electrical function of the tab 370a, and to provide the tab 370b as a single-piece part without deteriorating an electrical function of the tab 370b.

Although the present technology has been described herein with reference to one or more embodiments, the present technology is not limited thereto, and various modifications can be made to the present technology.

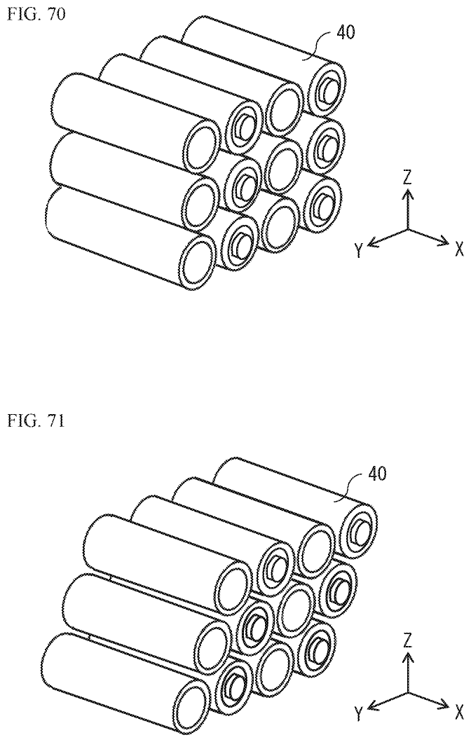

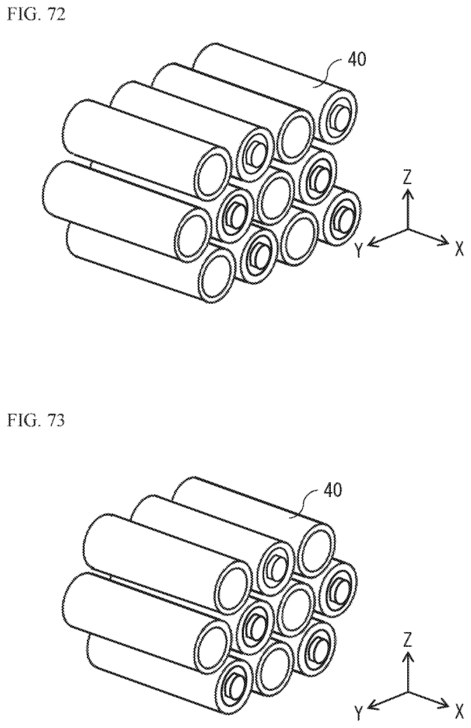

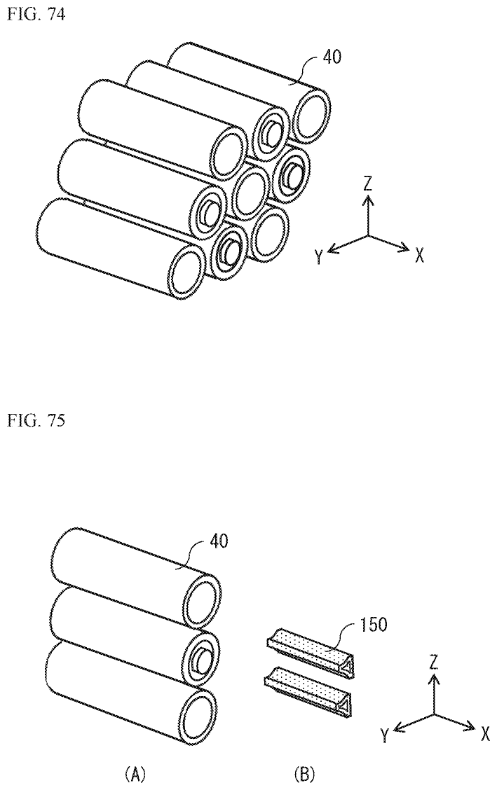

In the first embodiment, the multiple batteries 40 in the battery unit 20 may be stacked in three layers, for example, as illustrated in FIG. 70. In the fourth embodiment, the multiple batteries 40 in the battery unit 320 may be stacked in three layers, for example, as illustrated in FIGS. 71, 72, 73, and 74. In this case, the number of batteries 40 included in each of the layers may be the same as those in FIGS. 71, 72, and 74, for example. Further, the number of batteries 40 included in a specific layer may be different from those in other layers, for example, as illustrated in FIG. 73.

In the second embodiment, the battery unit 120 may include multiple batteries 40. In this case, the multiple batteries 40 may be arranged on the predetermined plane (the XY plane). Further, the multiple batteries 40 may be arranged in the predetermined plane (an XZ plane), for example, as illustrated in FIG. 75. In this case, the each of the heat-absorbing member 150 is disposed between two batteries 40 adjacent to each other in the Z direction, for example, as illustrated in FIG. 75.

Further, in the first embodiment and the fourth embodiment, the number of layers of the multiple batteries 40 in each of the battery units 20 and 320 is not limited to two, and may be three or more.

Further, the description has been given of the case where the secondary battery has a battery structure of a cylindrical type; however, the battery structure of the secondary battery to be applied to the battery pack of the present technology is not particularly limited in kind. Specifically, the battery structure of the secondary battery may be, for example, a prismatic type or a coin type.

The structures of the secondary battery are not particularly limited. Specifically, the secondary battery may have a structure other than a wound structure, such as a stacked structure.

For example, although lithium is used as the electrode reactant of the secondary battery, the electrode reactant is not particularly limited in kind. Specifically, the electrode reactant may be another element belonging to group 1 in the long period periodic table, such as sodium or potassium. The electrode reactant may be an element belonging to group 2 in the long period periodic table, such as magnesium or calcium. The electrode reactant may be another light metal such as aluminum.

The effects described herein are mere examples, and effects of the present technology are therefore not limited to those described herein. Accordingly, the present technology may achieve any other effect.

Note that the present technology may have any of the following configurations according to an embodiment.
<1>

A battery pack comprising a battery unit that includes:
multiple batteries;
one or more heat-absorbing members each including a heat-absorbing agent and a housing body housing the heat-absorbing agent, the one or more heat-absorbing members each extending in an axial direction of the batteries, and each being disposed to be adjacent to at least two of the batteries;
a battery holder that holds the batteries;
a first tab coupled to a terminal on one end side of each of the batteries; and
a second tab coupled to a terminal on another end side of each of the batteries, in which
the first tab is provided to cover, when the battery unit is viewed in the axial direction of the batteries, one end of each of the one or more heat-absorbing members, and
the second tab is provided to cover, when the battery unit is viewed in the axial direction of the batteries, another end of each of the one or more heat-absorbing members.
<2>

The battery pack according to <1>, in which
a number of the batteries is two,
a number of the one or more heat-absorbing members is one, and
the heat-absorbing member is disposed to be adjacent to the two batteries.
<3>

The battery pack according to <2>, in which
the batteries each include a positive electrode terminal at one end, and a negative electrode terminal at another end,
the two batteries are held by the battery holder to cause the respective positive electrode terminals of the two batteries to face in opposite directions along the axial direction of the batteries,
the first tab is a tab module including a first tab part coupled to the positive electrode terminal of one of the two batteries and a second tab part coupled to the negative electrode terminal of another one of the two batteries, and
the second tab is a tab module including an intermediate coupling tab part coupled to the negative electrode terminal of the one of the two batteries and to the positive electrode terminal of the other one of the two batteries.
<4>

The battery pack according to <3>, in which the first tab includes an overlap part in which the first tab part and the second tab part overlap each other.
<5>

The battery pack according to <4>, in which the overlap part is disposed at a position opposed to one end of the heat-absorbing member.
<6>

The battery pack according to <4>, in which the overlap part is not disposed at a position opposed to one end of the heat-absorbing member, and is disposed only at a position not opposed to the one end of the heat-absorbing member.
<7>

The battery pack according to <5> or <6>, in which the first tab includes an insulating layer that electrically insulates the first tab part and the second tab part from each other.
<8>

A battery pack including a battery unit that includes:
(2×n)-number of batteries, where n is an integer of two or more;
(n−1)-number of heat-absorbing members each including a heat-absorbing agent and a housing body housing the heat-absorbing agent, the (n−1)-number of heat-absorbing members each extending in an axial direction of the batteries;
a battery holder that holds the (2×n)-number of batteries in layered form;
a first tab coupled to a terminal on one end side of each of the (2×n)-number of batteries; and
a second tab coupled to a terminal on another end side of each of the (2×n)-number of batteries, in which
the (n−1)-number of heat-absorbing members are each disposed in corresponding one of (n−1)-number of gaps each surrounded by four batteries, out of the (2×n)-number of batteries, that are adjacent to each other,
the first tab is provided to cover, when the battery unit is viewed in the axial direction of the batteries, one end of each of the (n−1)-number of heat-absorbing members, and
the second tab is provided to cover, when the battery unit is viewed in the axial direction of the batteries, another end of each of the (n−1)-number of heat-absorbing members.
<9>

The battery pack according to <8>, in which
the batteries each include a positive electrode terminal at one end, and a negative electrode terminal at another end,
n is an integer of four or more,
out of the (2×n)-number of batteries, n-number of first batteries belonging to a first group are held by the battery holder to cause the respective positive electrode terminals of the first batteries to be on a side of the first tab in the axial direction of the batteries,
out of the (2×n)-number of batteries, n-number of second batteries belonging to a second group are held by the battery holder to cause the respective positive electrode terminals of the second batteries to be on a side of the second tab in the axial direction of the batteries,
the first tab is a tab module including
   a first tab part coupled to the respective positive electrode terminals of third batteries that are two or more, but not all, of the n-number of first batteries belonging to the first group,
   a second tab part coupled to the respective negative electrode terminals of fourth batteries that are two or more, but not all, of the n-number of second batteries belonging to the second group, and
   a first intermediate coupling tab part coupled to the respective positive electrode terminals of two or more fifth batteries, out of the n-number of first batteries belonging to the first group, that are other than the two or more third batteries, and to the respective negative electrode terminals of two or more sixth batteries, out of the n-number of second batteries belonging to the second group, that are other than the two or more fourth batteries, and
the second tab is a tab module including
   a second intermediate coupling tab part coupled to the respective negative electrode terminals of the two or more third batteries and to the respective positive electrode terminals of the two or more sixth batteries, and
   a third intermediate coupling tab part coupled to the respective positive electrode terminals of the two or more fourth batteries and to the respective negative electrode terminals of the two or more fifth batteries.
<10>

The battery pack according to <9>, in which
the first tab includes
   a first overlap part in which the first tab part and the first intermediate coupling tab part overlap each other, and
   a second overlap part in which the second tab part and the first intermediate coupling tab part overlap each other, and
the second tab includes a third overlap part in which the second intermediate coupling tab part and the third intermediate coupling tab part overlap each other.
<11>

The battery pack according to <10>, in which
the first overlap part is disposed at a position opposed to one end of the heat-absorbing member that is disposed between the two or more third batteries coupled to the first tab part and the two or more sixth batteries coupled to the first intermediate coupling tab part,
the second overlap part is disposed at a position opposed to one end of the heat-absorbing member that is disposed between the two or more fourth batteries coupled to the second tab part and the two or more fifth batteries coupled to the first intermediate coupling tab part, and
the third overlap part is disposed at a position opposed to another end of the heat-absorbing member that is disposed between the two or more fifth batteries coupled to the second intermediate coupling tab part and the two or more sixth batteries coupled to the third intermediate coupling tab part.
<12>

The battery pack according to <10>, in which
the first overlap part and the second overlap part are each not disposed at a position opposed to one end of each of the heat-absorbing members, and is disposed at a position not opposed to the one end of each of the heat-absorbing members, and
the third overlap part is not disposed at a position opposed to another end of each of the heat-absorbing members, and is disposed at a position not opposed to the other end of each of the heat-absorbing members.
<13>

The battery pack according to <11> or <12>, in which
the first tab includes a first insulating layer that electrically insulates both the first tab part and the second tab part from the first intermediate coupling tab part, and
the second tab includes a second insulating layer that electrically insulates the second intermediate coupling tab part and the third intermediate coupling tab part from each other.
<14>

A battery pack including a battery unit that includes:
(2×n+1)-number of batteries, where n is an integer of one or more;
(2×n−1)-number of heat-absorbing members each including a heat-absorbing agent and a housing body housing the heat-absorbing agent, the (2×n−1)-number of heat-absorbing members each extending in an axial direction of the batteries;
a battery holder that holds the (2×n+1)-number of batteries in layered form;
a first tab coupled to a terminal on one end side of each of the (2×n+1)-number of batteries; and
a second tab coupled to a terminal on another end side of each of the (2×n+1)-number of batteries, in which
the (2×n−1)-number of heat-absorbing members are each disposed in corresponding one of n-number of gaps each surrounded by three batteries, out of the (2×n+1)-number of batteries, that are adjacent to each other,
the first tab is provided to cover, when the battery unit is viewed in the axial direction of the batteries, one end of each of the (2×n−1)-number of heat-absorbing members, and
the second tab is provided to cover, when the battery unit is viewed in the axial direction of the batteries, another end of each of the (2×n−1)-number of heat-absorbing members.
<15>

The battery pack according to <14>, in which
the batteries each include a positive electrode terminal at one end, and a negative electrode terminal at another end,
n is 1,
out of the three batteries, two first batteries belonging to a first group are held by the battery holder to cause the respective positive electrode terminals of the first batteries to be on a side of the first tab in the axial direction of the batteries,
out of the three batteries, one second battery not belonging to the first group is held by the battery holder to cause the positive electrode terminal of the second battery to be on a side of the second tab in the axial direction of the batteries,
the first tab is a tab module including
   a first tab part coupled to the positive electrode terminal of a third battery that is one of the two first batteries belonging to the first group, and
   a first intermediate coupling tab part coupled to the positive electrode terminal of a fourth battery that is another one of the two first batteries belonging to the first group, and to the negative electrode terminal of the second battery not belonging to the first group, and
the second tab is a tab module including
   a second intermediate coupling tab part coupled to the negative electrode terminal of the third battery and to the positive electrode terminal of the second battery, and
   a second tab part coupled to the negative electrode terminal of the fourth battery.
<16>

The battery pack according to <15>, in which
the first tab includes a first overlap part in which the first tab part and the first intermediate coupling tab part overlap each other, and
the second tab includes a second overlap part in which the second intermediate coupling tab part and the second tab part overlap each other.
<17>

The battery pack according to <16>, in which
the first overlap part is disposed at a position opposed to one end of the heat-absorbing member that is surrounded by the third battery, the fourth battery, and the second battery, and
the second overlap part is disposed at a position opposed to another end of the heat-absorbing member that is surrounded by the third battery, the fourth battery, and the second battery.
<18>

The battery pack according to <16> or <17>, in which
the first tab includes a first insulating layer that electrically insulates the first tab part and the first intermediate coupling tab part from each other, and
the second tab includes a second insulating layer that electrically insulates the second intermediate coupling tab part and the second tab part from each other.
<19>

The battery pack according to <14>, in which
the batteries each include a positive electrode terminal at one end, and a negative electrode terminal at another end,
n is an integer of three or more,
the battery holder holds the (2×n+1)-number of batteries in two layers,
the (2×n+1)-number of batteries include two first batteries belonging to each of groups from a first group to an n-th group, and one second battery not belonging to any of the groups from the first group to the n-th group,
the two first batteries belonging to the first group are held by the battery holder to cause the respective positive electrode terminals of the first batteries to be on a side of the first tab in the axial direction of the batteries,
in each of the groups from the second group to the n-th group, one of the first batteries is held by the battery holder to cause the positive electrode terminal to be on the side of the first tab in the axial direction of the batteries, and another one of the first batteries is held by the battery holder to cause the positive electrode terminal to be on a side of the second tab in the axial direction of the batteries,
the one second battery not belonging to any of the groups from the first group to the n-th group is held by the battery holder to cause the positive electrode terminal to be on the side of the second tab in the axial direction of the batteries,
the first tab is a tab module including
   a first tab part coupled to the positive electrode terminal of one of the first batteries belonging to the n-th group,
   (n−1)-number of first intermediate coupling tab parts each coupled to the negative electrode terminal of one of the first batteries belonging to the k-th group, where k is any integer from 2 to n, and to the positive electrode terminal of one of the first batteries belonging to the (k−1)th group, and
   a second intermediate coupling tab part coupled to the positive electrode terminal of one first battery out of the two first batteries belonging to the first group, and to the negative electrode terminal of the second battery, and
the second tab is a tab module including
   a second tab part coupled to the negative electrode terminal of one of the first batteries belonging to the first group,
   (n−1)-number of third intermediate coupling tab parts each coupled to the negative electrode terminal of one of the first batteries belonging to the k-th group, where k is any integer from 2 to n, and to the positive electrode terminal of another one of the first batteries belonging to the k-th group, and
   a fourth intermediate coupling tab part coupled to the negative electrode terminal of another one of the first batteries belonging to the first group, and to the positive electrode terminal of the second battery.
<20>

The battery pack according to <19>, in which
the first tab includes
   a first overlap part in which the first tab part and the second intermediate coupling tab part overlap each other, and
   (n−1)-number of second overlap parts in each of which two adjacent ones of the first intermediate coupling tab parts overlap each other, and
the second tab includes
   a third overlap part in which the second tab part and the fourth intermediate coupling tab part overlap each other,
   a fourth overlap part in which the fourth intermediate coupling tab part and the third intermediate coupling tab part overlap each other, and
   (n−2)-number of fifth overlap parts in each of which two adjacent ones of the third intermediate coupling tab parts overlap each other.
<21>

The battery pack according to <19>, in which
the first overlap part is disposed at a position opposed to one end of the heat-absorbing member that is surrounded by the two first batteries and the one second battery,
the (n−1)-number of second overlap parts are each disposed at a position opposed to one end of the heat-absorbing member that is surrounded by three adjacent ones of the first batteries,
the third overlap part is disposed at a position opposed to another end of the heat-absorbing member that is surrounded by the two first batteries and the one second battery,
the fourth overlap part is disposed at a position opposed to another end of the heat-absorbing member that is surrounded by three adjacent ones of the first batteries, and
the (n−2)-number of fifth overlap parts are each disposed at a position opposed to another end of the heat-absorbing member that is surrounded by three adjacent ones of the first batteries.
<22>

The battery pack according to <20> or <21>, in which
the first tab includes
   a first insulating layer that electrically insulates the first tab part and the second intermediate coupling tab part from each other, and
   a second insulating layer that electrically insulates two adjacent ones of the first intermediate coupling tab parts from each other, and
the second tab includes
   a third insulating layer that electrically insulates the second tab part and the fourth intermediate coupling tab part from each other,
   a fourth insulating layer that electrically insulates the fourth intermediate coupling tab part and the third intermediate coupling tab part from each other, and
   a fifth insulating layer that electrically insulates two adjacent ones of the third intermediate coupling tab parts from each other.
<23>

The battery pack according to any one of <1> to <22>, in which
the first tab is provided to cover, when the battery unit is viewed in the axial direction of the batteries, one end of each of the one or more heat-absorbing members and at least a part of one end of each of the batteries, and
the second tab is provided to cover, when the battery unit is viewed in the axial direction of the batteries, another end of each of the one or more heat-absorbing members and at least a part of another end of each of the batteries.
<24>

The battery pack according to any one of <1> to <23>, in which
the batteries each include a terminal at each of one end and another end, and
the battery holder includes
   a first side plate part that covers, when the battery unit is viewed in the axial direction of the batteries, one end of each of the one or more heat-absorbing members, and also a location, of the one end of each of the batteries, excluding at least a part of the terminal, and
   a second side plate part that covers, when the battery unit is viewed in the axial direction of the batteries, another end of each of the one or more heat-absorbing members, and also a location, of the other end of each of the batteries, excluding at least a part of the terminal.
<25>

The battery pack according to any one of <1> to <24>, in which
the battery unit further includes a board,
the first tab includes a first hook engaged with the board, and
the second tab includes a second hook engaged with the board.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery pack comprising a battery unit that includes:
a plurality of batteries;
one or more heat-absorbing members each including a heat-absorbing agent and a housing body housing the heat-absorbing agent, the one or more heat-absorbing members each extending in an axial direction of the batteries, and each being disposed to be adjacent to at least two of the batteries;
a battery holder that holds the batteries;
a first tab coupled to a terminal on one end side of each of the batteries; and
a second tab coupled to a terminal on another end side of each of the batteries, wherein
the first tab is provided to cover, as viewed in the axial direction of the batteries, one end of each of the one or more heat-absorbing members, and
the second tab is provided to cover, as viewed in the axial direction of the batteries, another end of each of the one or more heat-absorbing members.

2. The battery pack according to claim 1, wherein
a number of the plurality of batteries is two batteries,
a number of the one or more heat-absorbing members is one, and
the heat-absorbing member is disposed to be adjacent to the two batteries.

3. The battery pack according to claim 2, wherein
the batteries each include a positive electrode terminal at one end, and a negative electrode terminal at another end,
the two batteries are held by the battery holder to cause the respective positive electrode terminals of the two batteries to face in opposite directions along the axial direction of the batteries,
the first tab is a tab module including a first tab part coupled to the positive electrode terminal of one of the two batteries and a second tab part coupled to the negative electrode terminal of another one of the two batteries, and
the second tab is a tab module including an intermediate coupling tab part coupled to the negative electrode terminal of the one of the two batteries and to the positive electrode terminal of the other one of the two batteries.

4. The battery pack according to claim 3, wherein the first tab includes an overlap part in which the first tab part and the second tab part overlap each other.

5. The battery pack according to claim 4, wherein the overlap part is disposed at a position opposed to one end of the heat-absorbing member.

6. The battery pack according to claim 4, wherein the overlap part is not disposed at a position opposed to one end of the heat-absorbing member, and is disposed only at a position not opposed to the one end of the heat-absorbing member.

7. The battery pack according to claim 5, wherein the first tab includes an insulating layer that electrically insulates the first tab part and the second tab part from each other.

8. A battery pack comprising a battery unit that includes:
(2×n)-number of batteries, where n is an integer of two or more;
(n−1)-number of heat-absorbing members each including a heat-absorbing agent and a housing body housing the heat-absorbing agent, the (n−1)-number of heat-absorbing members each extending in an axial direction of the batteries;
a battery holder that holds the (2×n)-number of batteries in layered form;
a first tab coupled to a terminal on one end side of each of the (2×n)-number of batteries; and
a second tab coupled to a terminal on another end side of each of the (2×n)-number of batteries, wherein
the (n−1)-number of heat-absorbing members are each disposed in a corresponding one of (n−1)-number of gaps each surrounded by four batteries, out of the (2×n)-number of batteries, that are adjacent to each other,
the first tab is provided to cover, as viewed in the axial direction of the batteries, one end of each of the (n−1)-number of heat-absorbing members, and
the second tab is provided to cover, as viewed in the axial direction of the batteries, another end of each of the (n−1)-number of heat-absorbing members.

9. The battery pack according to claim 8, wherein
the batteries each include a positive electrode terminal at one end, and a negative electrode terminal at another end,
n is an integer of four or more,
of the (2×n)-number of batteries, n-number of first batteries belonging to a first group are held by the battery holder to cause respective positive electrode terminals of the first batteries to be on a side of the first tab in the axial direction of the batteries,
of the (2×n)-number of batteries, n-number of second batteries belonging to a second group are held by the battery holder to cause respective positive electrode terminals of the second batteries to be on a side of the second tab in the axial direction of the batteries,
the first tab is a tab module including
a first tab part coupled to the respective positive electrode terminals of third batteries that are two or more, and not all, of the n-number of first batteries belonging to the first group,
a second tab part coupled to the respective negative electrode terminals of fourth batteries that are two or more, and not all, of the n-number of second batteries belonging to the second group, and
a first intermediate coupling tab part coupled to the respective positive electrode terminals of two or more fifth batteries, out of the n-number of first batteries belonging to the first group, that are other than the two or more third batteries, and to the respective negative electrode terminals of two or more sixth batteries, out of the n-number of second batteries belonging to the second group, that are other than the two or more fourth batteries, and
the second tab is a tab module including
a second intermediate coupling tab part coupled to the respective negative electrode terminals of the two or more third batteries and to the respective positive electrode terminals of the two or more sixth batteries, and
a third intermediate coupling tab part coupled to the respective positive electrode terminals of the two or more fourth batteries and to the respective negative electrode terminals of the two or more fifth batteries.

10. The battery pack according to claim 9, wherein
the first tab includes
a first overlap part in which the first tab part and the first intermediate coupling tab part overlap each other, and
a second overlap part in which the second tab part and the first intermediate coupling tab part overlap each other, and
the second tab includes a third overlap part in which the second intermediate coupling tab part and the third intermediate coupling tab part overlap each other.

11. The battery pack according to claim 10, wherein
the first overlap part is disposed at a position opposed to one end of the heat-absorbing member that is disposed between the two or more third batteries coupled to the first tab part and the two or more sixth batteries coupled to the first intermediate coupling tab part,
the second overlap part is disposed at a position opposed to one end of the heat-absorbing member that is disposed between the two or more fourth batteries coupled to the second tab part and the two or more fifth batteries coupled to the first intermediate coupling tab part, and
the third overlap part is disposed at a position opposed to another end of the heat-absorbing member that is disposed between the two or more fifth batteries coupled to the second intermediate coupling tab part and the two or more sixth batteries coupled to the third intermediate coupling tab part.

12. The battery pack according to claim 10, wherein
the first overlap part and the second overlap part are each not disposed at a position opposed to one end of each of the heat-absorbing members, and is disposed at a position not opposed to the one end of each of the heat-absorbing members, and
the third overlap part is not disposed at a position opposed to another end of each of the heat-absorbing members, and is disposed at a position not opposed to the other end of each of the heat-absorbing members.

13. The battery pack according to claim 11, wherein
the first tab includes a first insulating layer that electrically insulates both the first tab part and the second tab part from the first intermediate coupling tab part, and
the second tab includes a second insulating layer that electrically insulates the second intermediate coupling tab part and the third intermediate coupling tab part from each other.

14. A battery pack comprising a battery unit that includes:
(2×n+1)-number of batteries, where n is an integer of one or more;
(2×n−1)-number of heat-absorbing members each including a heat-absorbing agent and a housing body housing the heat-absorbing agent, the (2×n−1)-number of heat-absorbing members each extending in an axial direction of the batteries;
a battery holder that holds the (2×n+1)-number of batteries in layered form;
a first tab coupled to a terminal on one end side of each of the (2×n+1)-number of batteries; and
a second tab coupled to a terminal on another end side of each of the (2×n+1)-number of batteries, wherein
the (2×n−1)-number of heat-absorbing members are each disposed in corresponding one of n-number of gaps each surrounded by three batteries, out of the (2×n+1)-number of batteries, that are adjacent to each other,
the first tab is provided to cover, as viewed in the axial direction of the batteries, one end of each of the (2×n−1)-number of heat-absorbing members, and
the second tab is provided to cover, as viewed in the axial direction of the batteries, another end of each of the (2×n−1)-number of heat-absorbing members.

15. The battery pack according to claim 14, wherein
the batteries each include a positive electrode terminal at one end, and a negative electrode terminal at another end,
n is 1,
out of the three batteries, two first batteries belonging to a first group are held by the battery holder to cause the respective positive electrode terminals of the first batteries to be on a side of the first tab in the axial direction of the batteries,
out of the three batteries, one second battery not belonging to the first group is held by the battery holder to cause the positive electrode terminal of the second battery to be on a side of the second tab in the axial direction of the batteries,
the first tab is a tab module including
a first tab part coupled to the positive electrode terminal of a third battery that is one of the two first batteries belonging to the first group, and
a first intermediate coupling tab part coupled to the positive electrode terminal of a fourth battery that is another one of the two first batteries belonging to the first group, and to the negative electrode terminal of the second battery not belonging to the first group, and
the second tab is a tab module including
a second intermediate coupling tab part coupled to the negative electrode terminal of the third battery and to the positive electrode terminal of the second battery, and
a second tab part coupled to the negative electrode terminal of the fourth battery.

16. The battery pack according to claim 15, wherein
the first tab includes a first overlap part in which the first tab part and the first intermediate coupling tab part overlap each other, and
the second tab includes a second overlap part in which the second intermediate coupling tab part and the second tab part overlap each other.

17. The battery pack according to claim 16, wherein
the first overlap part is disposed at a position opposed to one end of the heat-absorbing member that is surrounded by the third battery, the fourth battery, and the second battery, and
the second overlap part is disposed at a position opposed to another end of the heat-absorbing member that is surrounded by the third battery, the fourth battery, and the second battery.

18. The battery pack according to claim 16, wherein
the first tab includes a first insulating layer that electrically insulates the first tab part and the first intermediate coupling tab part from each other, and
the second tab includes a second insulating layer that electrically insulates the second intermediate coupling tab part and the second tab part from each other.

19. The battery pack according to claim 14, wherein
the batteries each include a positive electrode terminal at one end, and a negative electrode terminal at another end,
n is an integer of three or more,
the battery holder holds the (2×n+1)-number of batteries in two layers,
the (2×n+1)-number of batteries include two first batteries belonging to each of groups from a first group to an n-th group, and one second battery not belonging to any of the groups from the first group to the n-th group,
the two first batteries belonging to the first group are held by the battery holder to cause the respective positive electrode terminals of the first batteries to be on a side of the first tab in the axial direction of the batteries,
in each of the groups from the second group to the n-th group, one of the first batteries is held by the battery holder to cause the positive electrode terminal to be on the side of the first tab in the axial direction of the batteries, and another one of the first batteries is held by the battery holder to cause the positive electrode terminal to be on a side of the second tab in the axial direction of the batteries,
the one second battery not belonging to any of the groups from the first group to the n-th group is held by the battery holder to cause the positive electrode terminal to be on the side of the second tab in the axial direction of the batteries,
the first tab is a tab module including
a first tab part coupled to the positive electrode terminal one of the first batteries belonging to the n-th group,
(n−1)-number of first intermediate coupling tab parts each coupled to the negative electrode terminal one of the first batteries belonging to the k-th group, where k is any integer from 2 to n, and to the positive electrode terminal of one the first batteries belonging to the (k−1)th group, and
a second intermediate coupling tab part coupled to the positive electrode terminal of one first battery out of the two first batteries belonging to the first group, and to the negative electrode terminal of the second battery, and
the second tab is a tab module including
a second tab part coupled to the negative electrode terminal of one of the first batteries belonging to the first group,
(n−1)-number of third intermediate coupling tab parts each coupled to the negative electrode terminal of one of the first batteries belonging to the k-th group, where k is any integer from 2 to n, and to the positive electrode terminal of another one of the first batteries belonging to the k-th group, and
a fourth intermediate coupling tab part coupled to the negative electrode terminal of another one of the first batteries belonging to the first group, and to the positive electrode terminal of the second battery.

20. The battery pack according to claim 19, wherein
the first tab includes
a first overlap part in which the first tab part and the second intermediate coupling tab part overlap each other, and
(n−1)-number of second overlap parts in each of which two adjacent ones of the first intermediate coupling tab parts overlap each other, and
the second tab includes
a third overlap part in which the second tab part and the fourth intermediate coupling tab part overlap each other,
a fourth overlap part in which the fourth intermediate coupling tab part and the third intermediate coupling tab part overlap each other, and
(n−2)-number of fifth overlap parts in each of which two adjacent ones of the third intermediate coupling tab parts overlap each other.

21. The battery pack according to claim 19, wherein
the first overlap part is disposed at a position opposed to one end of the heat-absorbing member that is surrounded by the two first batteries and the one second battery,
the (n−1)-number of second overlap parts are each disposed at a position opposed to one end of the heat-absorbing member that is surrounded by three adjacent ones of the first batteries,
the third overlap part is disposed at a position opposed to another end of the heat-absorbing member that is surrounded by the two first batteries and the one second battery,
the fourth overlap part is disposed at a position opposed to another end of the heat-absorbing member that is surrounded by three adjacent ones of the first batteries, and
the (n−2)-number of fifth overlap parts are each disposed at a position opposed to another end of the heat-absorbing member that is surrounded by three adjacent ones of the first batteries.

22. The battery pack according to claim 20, wherein
the first tab includes
a first insulating layer that electrically insulates the first tab part and the second intermediate coupling tab part from each other, and
a second insulating layer that electrically insulates two adjacent ones of the first intermediate coupling tab parts from each other, and
the second tab includes
a third insulating layer that electrically insulates the second tab part and the fourth intermediate coupling tab part from each other,
a fourth insulating layer that electrically insulates the fourth intermediate coupling tab part and the third intermediate coupling tab part from each other, and
a fifth insulating layer that electrically insulates two adjacent ones of the third intermediate coupling tab parts from each other.

23. The battery pack according to claim 1, wherein
the first tab is provided to cover, when the battery unit is viewed in the axial direction of the batteries, one end of each of the one or more heat-absorbing members and at least a part of one end of each of the batteries, and
the second tab is provided to cover, when the battery unit is viewed in the axial direction of the batteries, another end of each of the one or more heat-absorbing members and at least a part of another end of each of the batteries.

24. The battery pack according to claim 1, wherein
the batteries each include a terminal at each of one end and another end, and
the battery holder includes
a first side plate part that covers, when the battery unit is viewed in the axial direction of the batteries, one end of each of the one or more heat-absorbing members, and also a location, of the one end of each of the batteries, excluding at least a part of the terminal, and
a second side plate part that covers, when the battery unit is viewed in the axial direction of the batteries, another end of each of the one or more heat-absorbing members, and also a location, of the other end of each of the batteries, excluding at least a part of the terminal.

25. The battery pack according to claim 1, wherein
the battery unit further includes a board,
the first tab includes a first hook engaged with the board, and
the second tab includes a second hook engaged with the board.
